(19) United States
(12) Patent Application Publication
(10) Pub. No.: US 2021/0300651 A1
(43) Pub. Date: Sep. 30, 2021

(54) SUPER-HYDROPHOBIC THERMOPLASTIC FILMS FOR PACKAGING AND PACKAGES MADE THEREFROM

(71) Applicant: Cryovac, LLC, Charlotte, NC (US)

(72) Inventors: Roberto Forloni, RHO (MI) (IT); Xin Dong, Charlotte, NC (US)

(21) Appl. No.: 17/265,646

(22) PCT Filed: Aug. 3, 2018
(86) PCT No.: PCT/EP2018/071208

§ 371 Date: Feb. 3, 2021

(51) Int. Cl. B65D 65/42; B65D 75/00; B32B 27/08; B32B 27/20; B32B 7/022; B32B 7/028

(52) U.S. Cl. CPC B65D 65/42; B65D 2565/387; B32B 27/08; B32B 27/20; B32B 7/022; B32B 7/028; B32B 2307/31; B32B 2307/73; B32B 2439/70; B32B 2307/7242; B32B 2255/10; B32B 2255/20; B32B 2307/538; B32B 2307/72; B32B 2307/736; B32B 2264/303; B32B 2264/101; B32B 2264/025; B32B 2250/24; B65D 75/002

(57) ABSTRACT

The present invention relates to multilayer packaging films having an outer super-hydrophobic anti-abuse surface and to bags made therefrom, with the super-hydrophobic surface as the outermost surface. The packages made from the films of the invention do not get wet during post-packaging treatments requiring hot-water or steam such as shrinking, sterilization or pasteurization (FIG. 7A). At the exit of the shrinking apparatus, or of the sterilization or pasteurization apparatus, the packages do not need any final drying and can be directly placed into the cardboard boxes for shipment, with evident advantages of time and energy savings.

The present invention relates to thermoplastic films for packaging having a super-hydrophobic outer anti-abuse surface and to water-repellant packages made therefrom.

### BACKGROUND ART

Food packaging, in particular meat packaging, has long been done in thermoplastic vacuumized pouches and bags. These pouches and bags can be shrunk.

Typically, a conventional packaging cycle includes loading the product into the opened bag, vacuuming, sealing and, possibly, heat shrinking the package.

Heat-shrinking is generally effected in dedicated tanks or tunnels by submerging or by spraying the packages with hot water. The shrunk packages exiting the conventional shrinking operations are wet and necessitate a final drying. Traditionally, the final drying is time consuming and costly, if either done manually by operators or by blowing hot air blades. This last technology in particular requires space for the equipment and is energy consuming. Considering that meat-packaging plants are in general kept refrigerated at 4-5° C., it is clear that hot drying shrunk packages in a refrigerated environment is even more wasteful.

Other types of food can undergo thermal treatments (pasteurization or sterilization), even after packaging, to decrease their microbial load thus extending the shelf life. For example, baby food, sauces, eggs, drinks and beverages such as milk, wine, beer, fruit juices, undergo such thermal treatments.

In the pasteurization process, the food is treated with mild heat (<100 C) to reduce pathogens. The temperature and duration of the treatment depends on the type of food and the desired shelf life extension. Pasteurization of packaged food is carried out through hot water or steam.

Sterilization is more effective than pasteurization and aims at destroying or inactivating any possibly harmful biological agent such as bacteria, viruses, spores, prions, fungi, etc). One way through which sterilization can be obtained is through high temperatures (heat). A widely used equipment for heat sterilization is the autoclave, or steam sterilizer. Autoclaves use steam heated to over 100° C., under pressure.

Packages exiting either pasteurization operations or steam sterilization operations are wet and a drying step is necessary. Similarly to what described above for heat shrinking, the drying step is time consuming and costly and, especially if done by blowing hot air blades, is energy consuming and requires space for the equipment. In addition, as plants for packaging food undergoing heat treatment (in particular, e.g., milk, juices) are in general kept refrigerated, it follows that hot drying packages after a hot water or steam thermal treatment in a refrigerated environment is even more wasteful.

It is known that the outer surfaces of materials may be treated and/or coated with the aim to modify certain properties, in particular to increase the surface hydrophobicity. Depending on the treatments, the surface may become hydrophobic, namely with a water contact angle θ of at most 130°, or super-hydrophobic i.e. with a contact angle θ higher than 130° or even higher than 150°. The most common approach for creating super-hydrophobic surfaces is based on patterning roughness on a solid surface, followed by application of a thin layer of hydrophobic coating material. These treatments have been applied to several different solid materials such as textiles, metals, metal oxides, elastic polymers and ceramics.

The resulting super-hydrophobic coating would be more or less frail depending on the technology involved and, in certain applications, its durability might become a drawback.

In this respect achieving and, especially, maintaining super-hydrophobicity over time and under use, might be quite a challenge, particularly if the material treated is a very thin thermoplastic packaging film and the treated surface is the outer surface of the anti-abuse layer of said film.

In a conventional packaging cycle, the outer anti-abuse layer of the film is much more exposed to mechanical and thermal stress than the other outer (sealant) layer of the film. In fact, the outer anti-abuse layer is directly in contact with the hot sealing bars during sealing, it is subjected to surface wear caused by rubbing against moving parts of the packaging machine and by the abrasive action of the hot water in the final shrinking step. In particular, the coating might stick to the bars when sealed at the high temperatures. The adhesion of the coating to the sealing bars in the welding area might result in a weak seal and accordingly in a not hermetic package.

There are a few documents relating to super-hydrophobic films for packaging applications.

For instance, the article published in Adv. Mater. 2013, 25, 3085-3089 (Manna et al.) shows heat-shrinkable wrap films made super-hydrophobic by multilayer deposition of covalently linked branched poly(ethylenimine) and amino-reactive poly(vinyl-4,4-dimethylazalactone (PVDMA) followed by heat-shrinking. This procedure induces a microscale folding and wrinkling of the thin polymers coatings with creation of surface micro-roughness (“micro-worms” similar to those illustrated in FIG. 4A). The super-hydrophobic films described herein are neither sealed nor subjected to any real packaging cycle but rather manually overwrapped on glass rods.

The patents EP2397319B1 and EP2857190B1 (Toyo) describe super-hydrophobic multilayer packaging films having the sealant layer roughened by micro-particles and coated with a network of hydrophobic oxide fine particles. These films, characterized by low adherence to the packaged products, are used in tray lidding applications and, possibly, in bag making. In both cases, the super-hydrophobic surface in the final package is the innermost product-facing surface.

EP2397319B1 recognizes the problem of the abrasion of the super-hydrophobic layer from the sealant surface. According to this document, the particulate fillers present in the sealant layer, which form bumps and indentations in the surface, would entrap the hydrophobic oxide fine particles so preserving them from being removed. This patent neither considers the possibility to render super-hydrophobic the outer anti-abuse surface of the film nor provides any indication that the treatment would be durable enough when applied onto a surface exposed to much harsher conditions as the outer anti-abuse layer of a packaging film.

### SUMMARY OF THE INVENTION

The Applicant has found that, if common multilayer packaging films are rendered super-hydrophobic on the outer anti-abuse surface, bags made therefrom, with the super-hydrophobic surface as the outermost surface of the package, are not subjected to any wetting during a post-packaging hot-water or steam treatment (for example in the shrinking step or in a pasteurization or sterilization step). At the exit of the shrinking or thermal treatment apparatus, the bags do not need any final drying and can be directly placed into the cardboard boxes for shipment, with evident advantages of time and energy savings. Surprisingly, the super-hydrophobic coating applied onto the outer anti-abuse surface of the film neither interfere with nor is damaged by the harsh packaging operations, thus providing hermetical, dried packages. It is thus a first object of the present invention a super-hydrophobic thermoplastic optionally heat-shrinkable multilayer packaging film comprising:
an outer thermoplastic heat-sealable layer (A),
an inner thermoplastic mono or multilayer base layer (B) directly adhered to layer (A),
an outer super-hydrophobic coating (C) directly adhered to layer (B),
   wherein the surface of the base layer (B) directly adhered to the coating (C) is a rough surface and the outer surface of the coating (C) not directly adhered to layer (B), has a water contact angle θ measured according to test method ASTM D7490-13 higher than 130°.

A second object of the present invention is a process for the manufacture of the super-hydrophobic thermoplastic multilayer packaging film of the first object, which comprises:

i) providing a thermoplastic uncoated optionally heat-shrinkable film (A)/(B), comprising
a thermoplastic heat-sealable layer (A),
a thermoplastic mono or multilayer base layer (B) directly adhered to layer (A), wherein the surface of the base layer (B) not directly adhered to layer (A) is a rough surface,

ii) applying to the rough surface of the base layer (B) a hydrophobic coating composition,

iii) curing and/or drying the applied hydrophobic coating composition, thus forming a super-hydrophobic coating (C),

wherein the outer surface of the coating (C) not directly adhered to layer (B) has a water contact angle θ measured according to test method ASTM D7490-13 higher than 130°.

A third object of the present invention is a flexible optionally shrinkable article for packaging in the form of a seamless tubing or of a flexible container having at least an opening for introducing a product, the article being made from a film according to the first object, wherein the outermost surface of the article is the super-hydrophobic surface of coating (C) having a water contact angle θ measured according to test method ASTM D7490-13 higher than 130°.

A fourth object of the present invention is a hermetic, optionally vacuum shrunk package in which the film of the first object or the article of the third object hermetically enclose a product, wherein the outermost surface of the package is the super-hydrophobic surface of the coating (C) having a water contact angle θ measured according to test method ASTM D7490-13 higher than 130°.

A fifth object of the present invention is a packaging process for the manufacture of a hermetic package according to the fourth object, which comprises
providing an optionally shrinkable article for packaging according to the third object, having at least one opening,
inserting a product in the article through the opening,
sealing the article, optionally after vacuuming, thus forming a hermetic, optionally vacuum package, and
shrinking the package by contacting with hot water, and/or
pasteurizing or sterilizing the package by hot water or steam,

characterized in that it provides a dry package without any drying step.

A sixth object of the present invention is the use of the film according to the first object for the manufacture of a flexible package wherein the outermost surface of the package is a super-hydrophobic surface having a water contact angle θ measured according to test method ASTM D7490-13 higher than 130°.

### BRIEF DESCRIPTION OF THE DRAWINGS

The accompanying drawings are not necessarily drawn to scale.

FIGS. 1A and 1B are section drawings of exemplary films according to the invention. The film of FIG. 1A consists of an outer heat-sealable layer (A), an inner monolayer (B) and an outer coating (C). Regarding the film represented in FIG. 1B, the dotted lines mean that no, one or more layers may be present in the represented film structure. The film of FIG. 1B includes a gas barrier layer (F).

FIGS. 2A to 2C are section drawings of preferred tri-layers (FIG. 2A) or multi-layers (FIGS. 2B and 2C) films according to the invention, comprising a coating 0(C), an outermost layer 1, and a heat-sealable layer 2(A). In the case of multi-layers film (FIGS. 2B and 2C), also a layer 4 underlying the outermost layer 1 and possibly other layers between layer 4 and layer 2 (dotted lines) are present.

FIGS. 3A to 3C are pictures taken with a confocal microscope (magnification of the objective lens 20×) of a conventional uncoated film (FIG. 3A) and of two uncoated films, precursors of the films according to the invention, that incorporate micro-particles in layer 4 (FIG. 3B as sketched in FIG. 2B) and in layer 1 (FIG. 3A as sketched in FIG. 2C) respectively.

FIGS. 4A to 4E are Scanning Electron Microscopy (SEM) surface views of uncoated films having a rough surface, precursors of films according to different embodiments of the invention, in particular the surface roughness is due to, respectively, micro-worms (FIG. 4A), micro-holes (FIGS. 4B and 4C), nano-holes (FIG. 4D) and pillars (FIG. 4E), as further explained in the description.

FIGS. 5A-5D are sketches of embodiments of bags according to the invention. In these figures, the striped areas represent “fin seals” while dotted areas are “lap seals”. FIG. 6 is a block diagram of a process for applying a thin coating (C) to a film according to certain embodiments of the invention;

FIGS. 7A and 7B are pictures of meat packages according to the invention after the shrinking step in hot water (film of Ex1, FIG. 7A) and in comparison with a meat package made with a conventional film (C1) (FIG. 7B, conventional package with water droplets).

### DEFINITIONS

As used herein, the term “film” is inclusive of plastic web, regardless of whether it is film or sheet or tubing.

As used herein, the terms “inner layer” and “internal layer” refer to any film layer having both of its principal surfaces directly adhered to another layer of the film.

As used herein, the phrase “outer layer” or “external layer” refers to any film layer having only one of its principal surfaces directly adhered to another layer of the film.

As used herein, the phrases “seal layer”, “sealing layer”, “heat seal layer”, and “sealant layer”, refer to an outer layer involved in the sealing of the film to itself, in particular to the same outer seal layer or to the other outer layer of the same film, to another film, and/or to another article which is not a film.

As used herein, the words “tie layer” or “adhesive layer” refer to any inner film layer having the primary purpose of adhering two layers to each other.

As used herein, the phrases “longitudinal direction” and “machine direction”, herein abbreviated “LD” or “MD”, refer to a direction “along the length” of the film, i.e., in the direction of the film as the film is formed during coextrusion.

As used herein, the phrase “transverse direction” or “crosswise direction”, herein abbreviated “TD”, refers to a direction across the film, perpendicular to the machine or longitudinal direction.

As used herein, the term “extrusion” is used with reference to the process of forming continuous shapes by forcing a molten plastic material through a die, followed by cooling or chemical hardening. Immediately prior to extrusion through the die, the relatively high-viscosity polymeric material is generally fed into a rotating screw of variable pitch, i.e., an extruder, which forces the polymeric material through the die.

As used herein, the term “coextrusion” refers to the process of extruding two or more materials through a single die with two or more orifices arranged so that the extrudates merge and weld together into a laminar structure before chilling, i.e., quenching. The term “coextrusion” as used herein also includes “extrusion coating”.

As used herein, the term “extrusion coating” refers to processes by which a “coating” of molten polymer(s), comprising one or more layers, is extruded onto a solid “substrate” in order to coat the substrate with the molten polymer coating to bond the substrate and the coating together, thus obtaining a complete film.

As used herein the terms “coextrusion”, “coextruded”, “extrusion coating” and the like are referred to processes and multilayer films which are not obtained by sole lamination, namely by gluing or welding together pre-formed webs.

As used herein, the term “orientation” refers to “solid state orientation” namely to the process of stretching of the cast film carried out at a temperature higher than the Tg (glass transition temperatures) of all the resins making up the layers of the structure and lower than the temperature at which all the layers of the structure are in the molten state. The solid-state orientation may be mono-axial, transverse or, preferably, longitudinal, or, preferably, bi-axial.

As used herein, the phrases “orientation ratio” and “stretching ratio” refer to the multiplication product of the extent to which the plastic film material is expanded in the two directions perpendicular to one another, i.e. the machine direction and the transverse direction. Thus, if a film has been oriented to three times its original size in the longitudinal direction (3:1) and three times its original size in the transverse direction (3:1), then the overall film has an orientation ratio of 3×3 or 9:1.

As used herein the phrases “heat-shrinkable,” “heat-shrink,” and the like, refer to the tendency of the solid-state oriented film to shrink upon the application of heat, i.e., to contract upon being heated, such that the size of the film decreases while the film is in an unrestrained state.

As used herein, said term refers to solid-state oriented films with a free shrink in both the machine and the transverse directions, as measured by ASTM D 2732, of at least 10%, preferably at least 15%, even more preferably of at least 20% at 85° C.

As used herein, the term “film surface properties” relates to the common properties of the surface of plastic films such as surface energy, roughness and wettability.

As used herein, “vacuum deposition” refers to a process that allows depositing a material molecule-by-molecule or by groups of molecules forming a molecular chain on a solid surface to form a layer of this material. The material to be deposited may be a formulated monomer or oligomer in the form of a liquid or a solid. Upon application of vacuum and heat, the material evaporates and then deposits on the film surface. Upon deposition, the material returns to its original state which may be liquid, solid or even gel, if the material is formulated using both a liquid and a solid. As upon heating under vacuum the liquid or solid materials are converted into a vapor, this “vacuum deposition” process is also referred to as vacuum “vapor deposition” process.

As used herein, the term “outer anti-abuse surface” of a part of a film, of a film or of a package made therefrom means the outermost surface that, in the final package, is directed towards the environment and not towards the product. Accordingly, the outer anti-abuse surface of the base layer (B) is layer 1 while, in the coated film, the outer anti-abuse surface is the outer surface of the coating (C) not directly adhered to layer (B).

As used herein, the term “rough or roughened surface” refers to a surface of a film having a non-smooth pattern, i.e. a surface presenting micro and/or nano-sized irregularities such as, e.g., holes, pillars, spikes, wrinkles, scratches, bumps, indentations etc., wherein such structures are engraved in, or protrude from, the surface.

The term “contact angle θ” relates to the angle made by a droplet of liquid on a surface of a solid substrate and it is used as a quantitative measure of the wettability of the surface. If the liquid spreads completely across the surface and forms a film, the contact angle θ is 0°. For water, a surface or a coating is usually considered hydrophobic if the contact angle θ is greater than 90°. Surfaces or coatings with water contact angles greater than 130° are also referred to as “super-hydrophobic”.

As used herein, the term “super-hydrophobic” refers to the property of a surface to repel water very effectively. This property is expressed by a water contact angle θ exceeding 130°.

As used herein, the term “super-hydrophobic coating composition” refers to a composition that, when applied onto a surface of a thermoplastic film, may form a super-hydrophobic coating.

As used herein, the term “hydrophobic surface”, refers to the property of a surface to repel water with a water contact angle θ from about 90° to about 130. The term “hydrophilic”, as used herein, refers to surfaces with water contact angles θ well below 90°.

As used herein, the term “super-hydrophobic coating” relates to a coating characterized by a water contact angle θ higher than 130°, said contact angle θ being measured according to ASTM D7490-13.

As used herein, the term “hydrophobic coating composition” refers to a hydrophobic coating composition comprising components that have the ability to form a hydrophobic coating, upon curing and/or drying.

As used herein, the term “self-cleaning” refers to the property to repel water with the water roll-off angle on a tilting surface being below 10°. The roll-off angle, also named “sliding or gliding angle”, is the angle of inclination of a surface at which a drop rolls off it. As a rule, it is used to characterize super-hydrophobic surfaces with very high contact angles θ where the drop is approximately spherical. With smaller contact angles θ, although a drop can also move from the surface, it is usually initially deformed and then slides over the surface.

As used herein, the term “non-wettable surface” refers to a self-cleaning surface, namely to a surface that exhibits a water droplet roll-off angle of less than 10°.

As used herein, the term “inorganic coating” relates to a coating not including major amount of organic compounds, cross-linked or cured polymers, organic networks and the like. Preferably, an inorganic coating does not comprise organic compounds at all.

As used herein, the term “major amount” or “major proportion” refer to an amount of a component higher than 50% by weight in respect of the total amount of the components of a referred element (e.g. a film, a layer etc.).

As used herein, the term “minor amount” or “minor proportion” refer to an amount of a component lower than 50% by weight in respect of the total amount of the components of a referred element (e.g. a film, a layer etc.).

As used herein, the term “polymer” refers to the product of a polymerization reaction, and is inclusive of homo-polymers, and co-polymers.

As used herein, the term “homo-polymer” is used with reference to a polymer resulting from the polymerization of a single type of monomer, i.e., a polymer consisting essentially of a single type of mer, i.e., repeating unit.

As used herein, the term “co-polymer” refers to polymers formed by the polymerization reaction of at least two different types of monomers. For example, the term “co-polymer” includes the co-polymerization reaction product of ethylene and an alpha-olefin, such as 1-hexene. When used in generic terms the term “co-polymer” is also inclusive of, for example, ter-polymers. The term “co-polymer” is also inclusive of random co-polymers, block co-polymers, and graft co-polymers.

As used herein, the phrase “heterogeneous polymer” or “polymer obtained by heterogeneous catalysis” refers to polymerization reaction products of relatively wide variation in molecular weight and relatively wide variation in composition distribution, i.e., typical polymers prepared, for example, using conventional Ziegler-Natta catalysts, for example, metal halides activated by an organometallic catalyst, i. e., titanium chloride, optionally containing magnesium chloride, complexed to trialkyl aluminum and may be found in patents such as U.S. Pat. No. 4,302,565 to Goeke et al. and U.S. Pat. No. 4,302,566 to Karol, et al. Heterogeneous catalyzed copolymers of ethylene and an -olefin may include linear low-density polyethylene, very low-density polyethylene and ultra-low-density polyethylene. Some copolymers of this type are available from, for example, The Dow Chemical Company, of Midland, Mich., U.S.A. and sold under the trademark DOWLEX resins.

As used herein, the phrase “homogeneous polymer” or “polymer obtained by homogeneous catalysis” refers to polymerization reaction products of relatively narrow molecular weight distribution and relatively narrow composition distribution. Homogeneous polymers are structurally different from heterogeneous polymers, in that homogeneous polymers exhibit a relatively even sequencing of co-monomers within a chain, a mirroring of sequence distribution in all chains, and a similarity of length of all chains, i.e., a narrower molecular weight distribution. This term includes those homogeneous polymers prepared using metallocenes, or other single-site type catalysts, as well as those homogenous polymers that are obtained using Ziegler Natta catalysts in homogenous catalysis conditions.

The co-polymerization of ethylene and alpha-olefins under homogeneous catalysis, for example, co-polymerization with metallocene catalysis systems which include constrained geometry catalysts, i.e., monocyclopentadienyl transition-metal complexes is described in U.S. Pat. No. 5,026,798 to Canich. Homogeneous ethylene/alpha-olefin copolymers (E/AO) may include modified or unmodified ethylene/alpha-olefin copolymers having a long-chain branched (8-20 pendant carbons atoms) alpha-olefin comonomer available from The Dow Chemical Company, known as AFFINITY and ATTANE resins, TAFMER linear copolymers obtainable from the Mitsui Petrochemical Corporation of Tokyo, Japan, and modified or unmodified ethylene/ -olefin copolymers having a short-chain branched (3-6 pendant carbons atoms) -olefin comonomer known as EXACT resins obtainable from ExxonMobil Chemical Company of Houston, Tex., U.S.A.

As used herein, the term “polyolefin” refers to any polymerized olefin, which can be linear, branched, cyclic, aliphatic, aromatic, substituted, or unsubstituted. More specifically, included in the term polyolefin are homo-polymers of olefin, co-polymers of olefin, co-polymers of an olefin and an non-olefinic co-monomer co-polymerizable with the olefin, such as vinyl monomers, modified polymers thereof, and the like. Specific examples include polyethylene homo-polymer, polypropylene homo-polymer, polybutene homo-polymer, ethylene-alpha-olefin which are copolymers of ethylene with one or more -olefins (alpha-olefins) such as butene-1, hexene-1, octene-1, or the like as a comonomer, and the like, propylene-alpha-olefin co-polymer, butene-alpha-olefin co-polymer, ethylene-unsaturated ester co-polymer, ethylene-unsaturated acid co-polymer, (e.g. ethylene-ethyl acrylate co-polymer, ethylene-butyl acrylate co-polymer, ethylene-methyl acrylate co-polymer, ethylene-acrylic acid co-polymer, and ethylene-methacrylic acid co-polymer), ethylene-vinyl acetate copolymer, ionomer resin, polymethylpentene, etc.

As used herein, the term “Cyclo olefin copolymers (COC)” refers to amorphous, transparent thermoplastics produced by copolymerization of cycloolefins such as norbornene or cyclopentadiene with ethylene using a metallocene catalyst.

As used herein the term “ionomer” refers to the products of polymerization of ethylene with an unsaturated organic acid, and optionally also with an unsaturated organic acid (C1-C4)-alkyl ester, partially neutralized with a mono- or divalent metal ion, such as lithium, sodium, potassium, calcium, magnesium and zinc. Typical unsaturated organic acids are acrylic acid and methacrylic acid, which are thermally stable and commercially available. Unsaturated organic acid (C1-C4)-alkyl esters are typically (meth)acrylate esters, e.g. methyl acrylate and isobutyl acrylate. Mixtures of more than one unsaturated organic acid comonomer and/or more than one unsaturated organic acid (C1-C4)-alkyl ester monomer can also be used in the preparation of the ionomer.

As used herein, the phrase “modified polymer”, as well as more specific phrases such as “modified ethylene/vinyl acetate copolymer”, and “modified polyolefin” refer to such polymers having an anhydride functionality, grafted thereon and/or copolymerized therewith and/or blended therewith. Preferably, such modified polymers have the anhydride functionality grafted on or polymerized therewith, as opposed to merely blended therewith. As used herein, the term “modified” refers to a chemical derivative, e.g. one having any form of anhydride functionality, such as anhydride of maleic acid, crotonic acid, citraconic acid, itaconic acid, fumaric acid, etc., whether grafted onto a polymer, copolymerized with a polymer, or blended with one or more polymers, and is also inclusive of derivatives of such functionalities, such as acids, esters, and metal salts derived therefrom.

As used herein, the phrase “anhydride-containing polymer” and “anhydride-modified polymer” refer to one or more of the following: (1) polymers obtained by copolymerizing an anhydride-containing monomer with a second, different monomer, and (2) anhydride grafted copolymers, and (3) a mixture of a polymer and an anhydride-containing compound.

As used herein, the phrase “ethylene-alpha-olefin copolymer” refers to heterogeneous and to homogeneous polymers such as linear low density polyethylene (LLDPE) with a density usually in the range of from about 0.900 g/cc to about 0.930 g/cc, linear medium density polyethylene (LMDPE) with a density usually in the range of from about 0.930 g/cc to about 0.945 g/cc, and very low and ultra-low density polyethylene (VLDPE and ULDPE) with a density lower than about 0.915 g/cc, typically in the range 0.868 to 0.915 g/cc, and such as metallocene-catalyzed EXACT™ and EXCEED™ homogeneous resins obtainable from Exxon, single-site AFFINITY™ resins obtainable from Dow, and TAFMER™ homogeneous ethylene-alpha-olefin copolymer resins obtainable from Mitsui. All these materials generally include co-polymers of ethylene with one or more co-monomers selected from (C4-C10)-alpha-olefin such as butene-1, hexene-1, octene-1, etc., in which the molecules of the copolymers comprise long chains with relatively few side chain branches or cross-linked structures.

As used herein, the term “EVA” refers to ethylene and vinyl acetate copolymers. The vinylacetate monomer unit can be represented by the general formula: [CH3COOCH═CH2].

As used herein, the phrase “acrylates or acrylate-based resin” refers to homopolymers, copolymers, including e.g. bipolymers, terpolymers, etc., having an acrylate moiety in at least one of the repeating units forming the backbone of the polymer. In general, acrylate-based resins are also known as polyalkyl acrylates. Acrylate resins or polyalkyl acrylates may be prepared by any method known to those persons skill in the art. Suitable examples of these resins for use in the present invention include ethylene/methacrylate copolymers (EMA), ethylene/butyl acrylate copolymers (EBA), ethylene/methacrylic Acid (EMAA), ethylene/methyl methacrylate (EMMA), optionally modified with carboxylic or preferably anhydride functionalities, ionomers and the like. Such as LOTRYL 18 MA 002 by Arkema (EMA), Elvaloy AC 3117 by Du Pont (EBA), Nucrel 1202HC by Du Pont (EMAA), Surlyn 1061 by Du Pont (lonomer).

As used herein the term “polyamide” refers to high molecular weight polymers having amide linkages along the molecular chain, and refers more specifically to synthetic polyamides such as nylons. Such term encompasses both homo-polyamides and co-(or ter-) polyamides. It also specifically includes aliphatic polyamides or co-polyamides, aromatic polyamides or co-polyamides, and partially aromatic polyamides or co-polyamides, modifications thereof and blends thereof. The homo-polyamides are derived from the polymerization of a single type of monomer comprising both the chemical functions, which are typical of polyamides, i.e. amino and acid groups, such monomers being typically lactams or aminoacids, or from the polycondensation of two types of polyfunctional monomers, i.e. polyamines with polybasic acids. The co-, ter-, and multi-polyamides are derived from the copolymerization of precursor monomers of at least two (three or more) different polyamides. As an example in the preparation of the co-polyamides, two different lactams may be employed, or two types of polyamines and polyacids, or a lactam on one side and a polyamine and a polyacid on the other side. Exemplary polymers are polyamide 6, polyamide 6/9, polyamide 6/10, polyamide 6/12, polyamide 11, polyamide 12, polyamide 6/12, polyamide 6/66, polyamide 66/6/10, modifications thereof and blends thereof. Said term also includes crystalline or partially crystalline, aromatic or partially aromatic polyamides.

As used herein, the phrase “amorphous polyamide” refers to polyamides or nylons with an absence of a regular three-dimensional arrangement of molecules or subunits of molecules extending over distances, which are large relative to atomic dimensions. However, regularity of structure exists on a local scale. See, “Amorphous Polymers,” in Encyclopedia of Polymer Science and Engineering, 2nd Ed., pp. 789-842 (J. Wiley & Sons, Inc. 1985). This document has a Library of Congress Catalogue Card Number of 84-19713. In particular, the term “amorphous polyamide” refers to a material recognized by one skilled in the art of differential scanning calorimetry (DSC) as having no measurable melting point (less than 0.5 cal/g) or no heat of fusion as measured by DSC using ASTM 3417-83. Such nylons include those amorphous nylons prepared from condensation polymerization reactions of diamines with dicarboxylic acids. For example, an aliphatic diamine is combined with an aromatic dicarboxylic acid, or an aromatic diamine is combined with an aliphatic dicarboxylic acid to give suitable amorphous nylons.

As used herein, the term “polyester” refers to homopolymers or copolymers (also known as “copolyesters”) having an ester linkage between monomer units which may be formed, for example, by condensation polymerization reactions of lactones or by polymerization of dicarboxylic acid(s) and glycol(s). With the term “(co)polyesters” both homo and copolymers are intended.

As used herein, the term “aromatic polyester” refers to homopolymers or copolymers (also known as “copolyesters”) having an ester linkage between one or more aromatic or alkylsubstituted aromatic dicarboxylc acids and one or more glycols. The term “(co)polyesters” refer to both homo- and copolymers.

As used herein, the term “adhered” is inclusive of films which are directly adhered to one another using a heat-seal or other means, as well as films which are adhered to one another using an adhesive which is between the two films.

As used herein, the phrase “directly adhered”, as applied to layers, is defined as adhesion of the subject layer to the object layer, without a tie layer, adhesive, or other layer therebetween.

In contrast, as used herein, the word “between”, as applied to a layer expressed as being between two other specified layers, includes both direct adherence of the subject layer to the two other layers it is between, as well as a lack of direct adherence to either or both of the two other layers the subject layer is between, i.e., one or more additional layers can be imposed between the subject layer and one or more of the layers the subject layer is between.

As used herein the term “gas-barrier” when referred to a layer, to a resin contained in said layer, or to an overall structure, refers to the property of the layer, resin or structure, to limit to a certain extent passage through itself of gases.

When referred to a layer or to an overall structure, the term “gas-barrier” is used herein to identify layers or structures characterized by an Oxygen Transmission Rate (evaluated at 23° C. and 0% R.H. according to ASTM D-3985) of less than 500 cc/m2·day·atm, preferably lower than 100 cc/m2·day·atm, even more preferably lower than 50 cc/m2·day·atm.

As used herein the term “PVDC” refers to vinylidene chloride homopolymers or copolymers.

A PVDC copolymer, comprises a major amount of vinylidene chloride and a minor amount of one or more comonomers. A major amount is defined as one of more than 50%.

As used herein, the phrase “flexible container” is inclusive of bags and pouches, in particular of end-seal, side-seal, L-seal, U-seal bags and pouches, back-seamed tubings and seamless tubings.

As used herein, the phrase “an article for packaging in the form of a seamless tubing” relates to a tubing devoid of any seal, which is generally made of a multilayer film (co)extruded through a round die, optionally oriented, wherein the heat-sealing layer (A) is the innermost layer of the tubing.

As used herein, the term “package” is inclusive of packages made from such articles, i.e. flexible containers or tubings, by placing a product in the article and sealing the article so that the product is substantially surrounded by the film from which the packaging container is made.

As used herein, the term “pouch” refers to a packaging container having an open top, side edges, and a bottom edge. The term “pouch” encompasses lay-flat pouches, pouches, casings (seamless casings and back-seamed casings, including lap-sealed casings, fin-sealed casings, and butt-sealed back-seamed casings having backseaming tape thereon). Various casing configurations are disclosed in U.S. Pat. No. 6,764,729 and various pouch configurations, including L-seal pouches, back-seamed pouches, and U-seal pouches, are disclosed in U.S. Pat. No. 6,790,468.

As used herein the term “average particle diameter” refers to the average diameter measured with a scanning electron microscope (FE-SEM), which can also be used in combination with another electron microscope such as a transmission electron microscope if the resolution of the scanning electron microscope is too low. Specifically, taking the particle diameter when the particles are spherical and the average of the longest dimension and shortest dimension as the diameter when they are non-spherical, the average particle diameter is the average of the diameters of 20 randomly-selected particles observed by scanning electron microscopy or the like.

As used herein the term “micro-particles” refers to particle having an average particle diameter from 0.5 to 100 microns.

As used herein the term “nanoparticles” refers to particle having an average particle diameter from 3 to 100 nm.

Unless otherwise stated, all the percentages are percentages by weight.

### DETAILED DESCRIPTION OF THE INVENTION

A first object of the present invention is a super-hydrophobic thermoplastic optionally heat-shrinkable multilayer packaging film, comprising:
an outer thermoplastic heat-sealable layer (A),
an inner thermoplastic mono or multilayer base layer (B) directly adhered to layer (A),
an outer super-hydrophobic coating (C) directly adhered to layer (B),
   wherein the surface of the base layer (B) directly adhered to the coating (C) is a rough surface and the outer surface of the coating (C) not directly adhered to layer (B), has a water contact angle θ measured according to test method ASTM D7490-13 higher than 130°.

In the following description and figures, the coating (C) is also numbered as (0), the outermost layer of the multilayer base layer (B), as (1), the heat-sealable layer as (2), the optional micro-particles as (3) and the layer of the base layer (B) directly adhered to layer (1) as layer (4).

The film according to the invention comprises an outer thermoplastic heat-sealable layer (A).

Preferably, the heat-sealable layer (A) of the present film comprises a major amount of a polymer selected among ethylene-vinyl acetate copolymers (EVA), polyethylenes, homogeneous or heterogeneous, linear ethylene- alpha -olefin copolymers, polypropylene copolymers (PP), ethylene-propylene copolymers (EPC), acrylates and methacrylates, ionomers, polyesters and their blends.

Preferably, the heat-sealable layer (A) comprises more than 60% 70%, 80%, 90%, 95%, by weight with respect to the same layer, more preferably substantially consists, of one or more of said polymers.

EVA is a copolymer formed from ethylene and vinyl acetate monomers wherein the ethylene units are present in a major amount and the vinyl-acetate units are present in a minor amount. The typical amount of vinyl-acetate may range from about 5 to about 20%.

Particularly, preferred polymer for the heat-sealable layer (A) are heterogeneous materials as linear low density polyethylene (LLDPE) with a density usually in the range of from about 0.910 g/cc to about 0.930 g/cc, linear medium density polyethylene (LMDPE) with a density usually in the range of from about 0.930 g/cc to about 0.945 g/cc, and very low and ultra-low density polyethylene (VLDPE and ULDPE) with a density lower than about 0.915 g/cc; and homogeneous polymers such as metallocene-catalyzed EXACT™ and EXCEED™ homogeneous resins obtainable from Exxon, single-site AFFINITY™ resins obtainable from Dow, QUEO by Borealis, TAFMER™ homogeneous ethylene-alpha-olefin copolymer resins obtainable from Mitsui. All these materials generally include co-polymers of ethylene with one or more co-monomers selected from (C4-C10)-alpha-olefin such as butene-1, hexene-1, octene-1, etc., in which the molecules of the copolymers comprise long chains with relatively few side chain branches or cross-linked structures.

These polymers can be advantageously blended in various percentages to tailor the sealing properties of the films depending on their use in packaging, as well known by those skilled in the art.

In a preferred embodiment, the heat-sealable layer (A) consists of blends of LLDPE and m-PE resins.

Preferably, the resins for the heat-sealable layer (A) have a seal initiation temperature lower than 110° C., more preferably lower than 105° C., and yet more preferably lower than 100° C.

The heat-sealable layer (A) of the film of the present invention may have a typical thickness from 2 to 30 microns, preferably from 3 to 25 microns, more preferably from 4 to 20 microns.

The film according to the present invention comprises a thermoplastic mono or multilayer base layer (B) directly adhered to layer (A).

The surface of the base layer (B) not directly adhered to layer (A) is a rough surface. Preferably, the rough surface of layer (B) is characterized by roughness values of Mean Roughness (Roughness Average) Ra, Root Mean Square (RMS) Roughness Rq and Mean Roughness Depth Rz measured according to ISO4287 as specified hereinafter.

In a first embodiment, the base layer (B) consists of a single layer (b).

The monolayer (b) comprises one or more thermoplastic resins commonly used in the manufacture of packaging films.

Preferably, in this first embodiment of the film, the layer (b) comprises a major proportion of, more preferably consists of, one or more thermoplastic resins selected from polyethylenes, polypropylenes, ethylene vinyl acetates (EVAs), ionomers, polyamides, polyesters, optionally blended with adhesive resins, such as anhydride-modified polyolefins, in order to improve the adhesion to the heat-sealable layer.

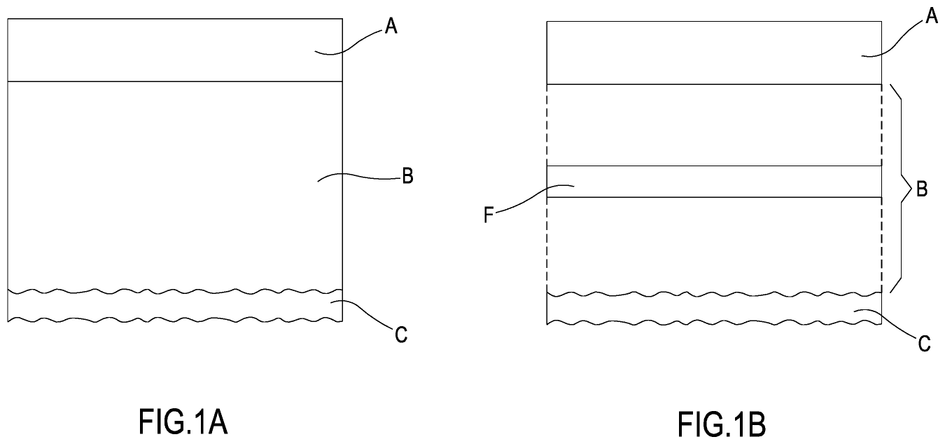

FIG. 1A illustrates a section of a film of the invention having a monolayer base layer (b). This film comprises the base layer (b), a heat-sealable layer (A) directly adhered to a surface of the base layer (b) and a coating (C) directly adhered to the other (rough) surface of the base layer (b).

The layer (b) in this first embodiment may have a typical average thickness from 15 to 80 microns, more preferably from 20 to 70 microns, depending on the final packaging use.

The surface of the base layer (b) not directly adhered to layer (A) is rendered rough by known surface mechanical, physical or chemical treatments or by incorporation of micro-particles in the bulk layer (b), as explained later on in the present description.

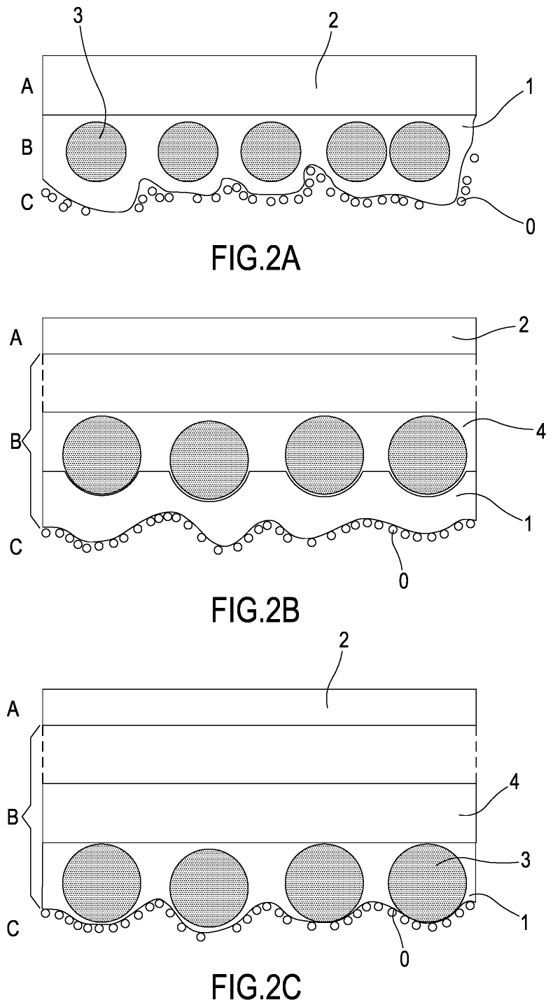

FIG. 2A illustrates a preferred embodiment of the film of the invention, comprising a monolayer (b) (1), incorporating micro-particles (3), a coating (C) (0) and a heat-sealable layer (A) (2).

In this embodiment, the thickness of layer (b) together with the diameter of the micro-particles (3) are important to get the desired surface roughness.

In this preferred embodiment, the skilled technician can modulate the thickness of layer (b) in order to get a more or less roughening of the surface, adapting the thickness to the diameter of the micro-particles or vice versa, by selecting micro-particles of a diameter tailored onto layer (b) desired thickness.

In order to achieve super-hydrophobicity, the rough surface of layer (b) is then coated with a suitable hydrophobic coating composition as described for the films including a multilayer base layer (B) herein below.

In a second embodiment, the base layer (B) comprises two or more layers of thermoplastic resins.

FIG. 1B shows a section drawing of a film according to this second embodiment comprising a multilayer base layer (B) with an inner gas-barrier layer (F), an outer heat-sealable layer (A), an outer coating (C) and one or more additional inner layers (dotted lines).

The multilayer base layer (B) may include further layers.

For instance, the multilayer base layer (B) may include one or more inner tie layers (D) having the main function of improving adhesion between the layers.

The tie layer (D) comprises a major proportion of, preferably consists of, one or more adhesive polymers selected among polyolefins and modified polyolefins.

Specific, not limitative, examples of adhesive resins include ethylene-vinyl acetate copolymers, ethylene-(meth)acrylate copolymers, ethylene-alpha-olefin copolymers, any of the above modified with carboxylic or anhydride functionalities, elastomers, and blends thereof.

The tie layer (D) may comprise at least one styrene-based polymer selected from the group consisting of styrene-ethylene-butylene-styrene copolymer, styrene-butadiene-styrene copolymer, styrene-isoprene-styrene copolymer, styrene-ethylene-butadiene-styrene copolymer, and styrene-(ethylene-propylene rubber)-styrene copolymer.

The tie layer (D) may have a typical thickness from 2 to 15 microns, preferably from 3 to 10 microns.

The multilayer base layer (B) may include an outer anti-abuse layer (E) (layer 1 in the films of FIGS. 2B and 2C) which, in the flexible container, is the outermost layer. The polymer(s) for the outer anti-abuse layer (E) may be selected for its heat resistance during the sealing step. In fact, may be advantageous to use for this layer a polymer having a melting point higher than the melting point of the polymer of the heat-sealable layer (A).

The outer anti-abuse layer (E), preferably comprises a major proportion of, preferably consists of, a polymer selected among polyolefins, ethylene-vinyl acetate copolymers, ionomers, (meth)acrylates copolymers, polyamides, polyesters and their blends.

The surface of the outer anti-abuse layer (E) not adhered to an inner layer may be superficially treated and /or coated in order to modify its surface properties.

The multilayer base layer (B) may include an inner gas barrier layer (F).

The inner gas barrier layer (F) of the present film preferably comprises a major proportion of, preferably consists of, a polymer selected among polyvinyl alcohol copolymers (PV/A), ethylene/vinyl alcohol copolymers (EVOH), polyvinyl chlorides (PVC), polyvinylidene chloride copolymers (PVDC), polyvinylidene chloride/vinylchloride copolymers (PVDC-VC), polyvinylidene chloride/methyl acrylate copolymers (PVDC/MA), blends of polyvinylidene chloride/vinylchloride copolymers (PVDC/VC) and polyvinylidene chloride/methyl acrylate copolymers (PVDC/MA), blends of PVdC and polycaprolactone (as those described in patent EP2064056 B1, example 1 to 7, particularly useful for respiring food products as certain cheeses), polyester homopolymers and copolymers, polyamide homopolymers and copolymers and their blends.

The inner gas barrier layer (F) of the present films may comprise at least 70%, at least 80%, at least 90%, at least 95% of polyvinylidene chloride, preferably consists of polyvinylidene chloride. With polyvinylidene chloride, homopolymers of vinylidene chloride or its copolymers with other suitable monomers in minor amount are meant. Preferred polymers for the gas barrier layer (F) layer are PVDC copolymers. Especially preferred copolymers are vinylidene chloride-methyl acrylate copolymers, vinylidene chloride-vinyl chloride copolymers, vinylidene chloride-acrylonitrile copolymers and vinylidene chloride-methyl acrylate-vinyl chloride terpolymers. Preferably, the present films comprise only one internal gas barrier layer (F) comprising polyvinylidene chloride.

In another embodiment, the inner barrier layer (F) comprises EVOH, optionally in admixture with polyamides.

The multilayer base layer (B) may comprise additional layers, such as stiff layer(s) (G) or bulk layer(s) (H).

The stiff layer(s) (G) preferably comprise a major proportion of, preferably consists of, a stiff polymer selected among polyamides, polyesters, HDPE, polypropylenes, cyclic olefin copolymers (COC), polystyrenes and their blends.

Preferably, in case of packaging of hot products or for cook-in applications, the present film may include one or more layer(s) of thermo-resistant materials such as for instance aromatic polyesters or polyamides commonly used in ovenable packages (see for instance EP2527142A1 and EP1393897A2 and the thermal resistant materials mentioned therein).

If present, preferably the overall thickness of stiff or thermo-resistant stiff layers (G) is higher than 5% and lower than 50%, more preferably higher than 10% and/or lower than 40% with respect to the film total thickness.

The bulk layer(s) (H) preferably comprise a major proportion of, preferably consists of, a polymer selected among EVA, acrylate based resins, ionomers, polyolefins, modified polyolefins and their admixtures.

Preferably, the overall thickness of the one or more bulk layers (H) is lower than 60%, more preferably lower than 40% and/or higher than 10%, more preferably higher than 20% with respect to the total film thickness.

The layers of the present film may contain appropriate amounts of additives typically included in such polymer compositions.

These additives include slip and anti-block agents such as talc, waxes, silica, and the like, antioxidants, stabilizers, plasticizers, fillers, pigments and dyes, cross-linking inhibitors, cross-linking enhancers, UV absorbers, odor absorbers, oxygen scavengers, antistatic agents, anti-fog agents or compositions, and the like additives known to those skilled in the art of packaging films.

Preferred non-exhaustive layer sequences for the film of the present invention are the following:
(A)/(b)/(C), (A)/(E)/(C), (A)/(D)/(E)/(C), (A)/(D)/(F)/(D)/(E)/(C), (A)/(H)/(D)/(F)/(D)/(H)/(E)/(C), (A)/(D)/(H)/(D)/(F)/(D)/(H)/(D)/(E)/(C), (A)/(H)/(D)/(F)/(D)/(H)/(E)/(C), (A)/(H)/(D)/(F)/(D)/(G)/(C), (A)/(H)/(D)/(F)/(D)/(H)/(G)/(C), (A)/(H)/(D)/(F)/(D)/(H)/(D)/(G)/(C).
   wherein layer (A) is the heat-sealable layer, layer b) is the monolayer base layer (B), layer (C) is the coating, layer (D) is a tie layer, layer (E) is an outer anti-abuse layer, layer (F) is an inner gas barrier layer, layer (G) is a stiff layer, layer (H) is a bulk layer.

The film of the present invention is characterized by having an outer super-hydrophobic surface.

The super-hydrophobicity may be conferred by roughening the surface of the base layer (B) not in contact with the heat-sealable layer (A) followed by coating said rough surface with a coating (C).

The surface of the base layer (B) not directly adhered to layer (A) is a rough surface. Preferably, the rough surface of layer (B) is characterized by roughness values of Ra, Rq and Rz measured according to ISO4287 as specified hereinafter.

There are several known techniques suitable to roughen the outer surface of the base layer (B).

In a preferred embodiment of the present film, the roughness is achieved by incorporation of micro-particles in the base layer (B).

Preferably, the micro-particles are incorporated into the outermost layer (1) of the base layer (B) or in the layer (4) directly adhered to layer (1) (see FIGS. 2B and 2C). The micro-particles incorporated in the base layer (B) of the film of the invention, make the surface of the film rough, with peaks and indentations.

Preferably, in layer (B) the film of the invention comprises micro-particles having an average particle diameter from 0.5 to 100 microns.

Preferably, the micro-particles have an average particle diameter from 5 to 80 microns, more preferably from 10 to 60 microns, according to laser particle-size distribution analysis.

In order to be effective in roughening the film surface, the micro-particles preferably have an average particle diameter of at least 20%, preferably at least 30%, more preferably at least 50% greater than the thickness of the layer of the film in which said particles are incorporated.

The micro-particles may comprise an organic component and/or an inorganic component.

The organic component may be selected, for instance, among acrylic resin, urethane resin, melamine resin, amino resin, epoxy resin, polyethylene resin, polystyrene resin, polypropylene resin, polyester resin, cellulose resin, vinyl chloride resin, polyvinyl alcohol, ethylene-vinylacetate copolymer, ethylene-vinyl alcohol copolymer, ethylene-ethyl acrylate copolymer, polyacrylonitrile or polyamide. The inorganic component may be selected, for instance, among aluminum, copper, iron, titanium, silver, calcium and other metals or alloys or intermetallic compounds containing these, silicon oxide, aluminum oxide, zirconium oxide, titanium oxide, iron oxide and other oxides, calcium phosphate, calcium stearate and other inorganic acid salts or organic acid salts, glass, aluminum nitride, boron nitride, silicon carbide, silicon nitride and other ceramics.

Preferably, the micro-particles component(s) are selected among acrylic micro-particles, silica micro-particles, boron silicate micro-particles, calcium phosphate micro-particles, calcium stearate micro-particles, glass micro-particles and charcoal powders.

Preferably, the micro-particles are selected from acrylic micro-particles and glass micro-particles.

Suitable micro-particles are for instance microbeads of acrylates such as Altuglas B100 (average particle size 30 microns) and Altuglas B130 (average particle size of 20 microns) from Arkema, solid glass micro-particles such as Spheriglass 3000 (average particle size of 35 microns), hollow glass microbeads such as Sphericel® 60P18 (average particle size of 20 microns) from Potters Industries, Eccospheres® SID230Z (average particle size of 55 microns) from Trelleborg or boron silicate microbeads such as iM30K from 3M (average particle size of 18 microns).

The micro-particles may have any form such as spherical, spheroid, indeterminate form, teardrop, flake or the like.

Preferably, the micro-particles are solid (i.e. not hollow or porous) micro-particles, as they are more resistant to the extrusion conditions and provide a better surface roughness.

The content of the micro-particles in the thermoplastic layer(s)—which corresponds to layer (b) in case of monolayer base layer (B) or to layers (1) and/or (4) and, optionally, to further other inner layer(s), in case of multilayer base layer (B)—may be varied appropriately according to the types of thermoplastic polymer(s) and micro-particles, the desired physical properties and the like.

In general, the content of micro-particles is from 1 to 80%, preferably 3 to 50%, more preferably from 15 to 35%, based on the total weight of the thermoplastic layer(s) in which they are incorporated.

FIG. 2B shows a sketched section of a preferred film having a multilayer base layer (B). This film comprises the heat-sealable layer (A) (2), the multilayer base layer (B) which includes the outermost anti-abuse layer (1), the layer (4) directly adhered to layer (1) incorporating the micro-particles (3), other optional layers (dotted-lines) and the coating (C) (0) of hydrophobic oxide nanoparticles, directly adhered to layer (1).

FIG. 2C shows a sketched section of a preferred film having a multilayer base layer (B). This film comprises the heat-sealable layer (A) (2), the multilayer base layer (B) which includes the outermost anti-abuse layer (1), incorporating the micro-particles (3), the layer (4) directly adhered to layer (1), other possible layers (dotted-lines) and the coating (C) (0) of hydrophobic oxide nanoparticles, directly adhered to layer (1).

According to the preferred embodiments of FIGS. 2B and 2C, the multilayer base layer (B) comprises micro-particles in the layer (4) directly adhered to the outer anti-abuse layer (1) or in the outer anti-abuse layer (1) respectively or in both (not illustrated).

Optionally, micro-particles may further be present in other internal film layers.

Preferably, the micro-particles are not incorporated into the barrier layer (F) to avoid damages to its gas barrier properties.

Preferably, the micro-particles are incorporated in layer (1) only.

The thickness of layers (1) and/or (4) together with the diameter of the micro-particles are important to get the desired surface roughness.

The skilled technician can modulate the thickness of those layers in order to get a more or less roughening of the surface, adapting the thickness to the diameter of the micro-particles or vice versa, selecting micro-particles of a diameter tailored onto those layers thickness.

Depending on the position of the micro-particles in the base layer (B), also the second outer surface of the base layer (B), namely the surface directly adhered to layer (A), may be roughened.

Optionally, the surface of the base layer (B) not directly adhered to layer (A) already roughened by the micro-particles, may be further subjected to other surface roughening treatments.

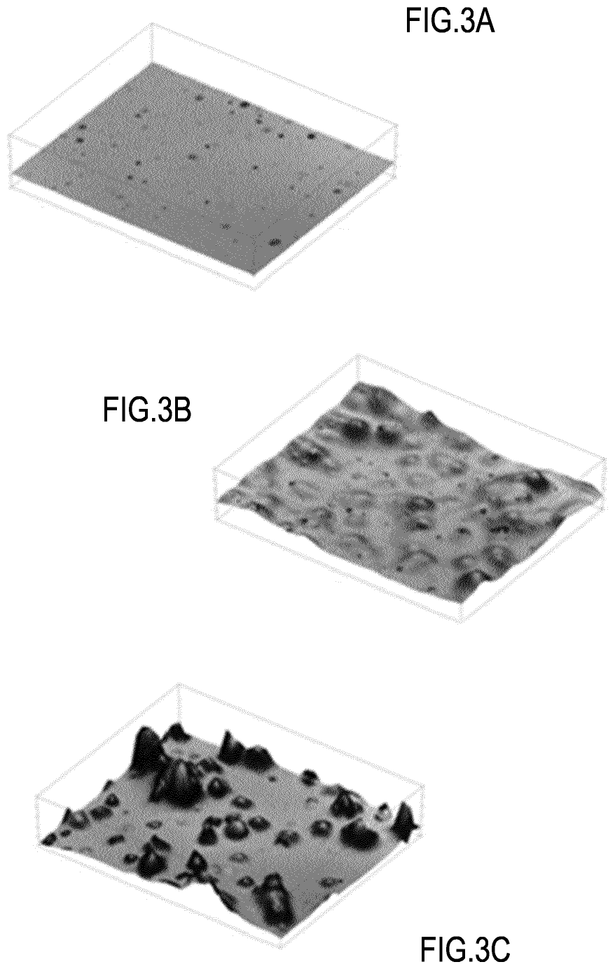

FIGS. 3 A-C show the roughening effect of the incorporation of micro-particles in the base layer (B). In particular, FIG. 3A illustrates the smooth surface of an uncoated control film (C1) without incorporated micro-particles. FIG. 3B shows the surface of an uncoated film A/B precursor of the coated film of the invention (Ex. 1) having micro-particles in the layer (4) underlying the outer anti-abuse layer (1). FIG. 3C shows the very rough surface of an uncoated film A/B precursor of the coated film of the invention (Ex. 2) having micro-particles in the outer anti-abuse layer (1).

Other techniques suitable to roughen the surface of the base layer (B) are described herein after, in relation to the process for the manufacture of the present film.

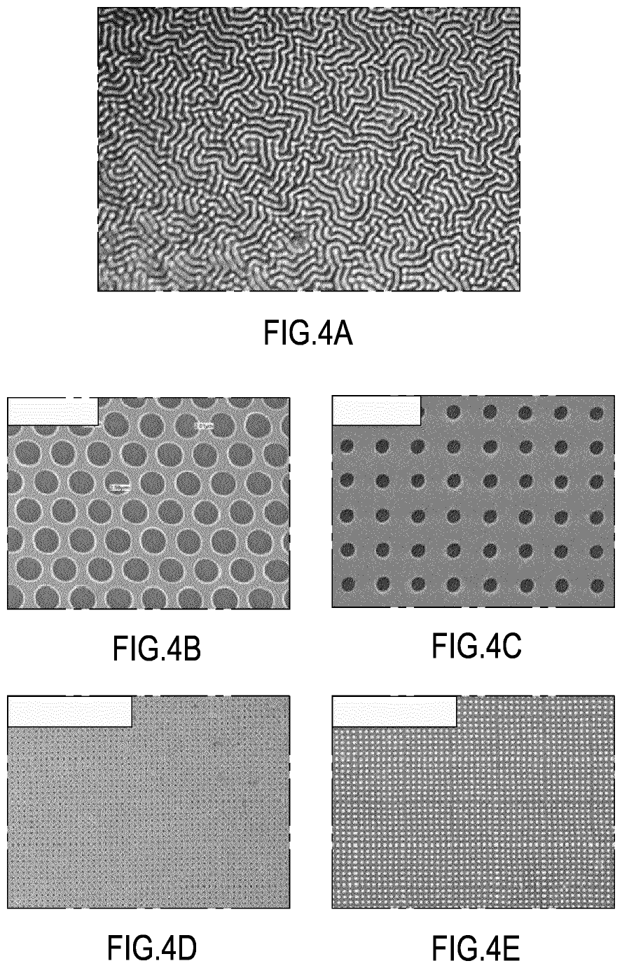

FIGS. 4 A-E show the roughening effect of some of these techniques.

In the present films, the rough surface of the base layer (B) when coated provides for a corresponding roughness on the outer surface of the coating (C).

Also the roughness of the outer surface of the coating (C) of the present films may be expressed in terms of Mean Roughness (Roughness Average Ra), Root Mean Square (RMS) roughness (Rq) and Mean Roughness Depth (Rz) measured according to ISO04287.

Preferably, this surface is characterized by Ra higher than 0.32 μm and/or by Rq higher than 0.39 μm and/or by Rz higher than 2.42 μm, measured according to ISO4287.

Preferably, in one embodiment, this surface is characterized by Ra higher than 0.35 μm and/or by Rq higher than 0.42 μm and/or by Rz higher than 2.96 μm, measured according to ISO4287.

Preferably, in another embodiment, this surface is characterized by Ra higher than 0.54 μm and/or by Rq higher than 0.65 μm and/or by Rz higher than 4.48 μm, measured according to ISO4287.

In the present films, the outer rough surface of the base layer (B) not adhered to layer (A) is coated by a coating (C) in order to modify its surface properties, in particular to increase its hydrophobicity.

The coating (C) comprises one or more organic or inorganic hydrophobic components selected among fluoropolymers, polysiloxanes, hydrophobic nanoparticles, such the hydrophobic oxides previously mentioned, in particular silica and silica precursors as tetraethyl orthosilicate (TEOS) and the like, or super-hydrophobic waxes.

Preferably, the coating includes hydrophobic oxide nanoparticles, more preferably hydrophobic oxide nanoparticles selected among silica (silicon dioxide), alumina, magnesium oxide, titania and their admixtures.

The film according to the present invention preferably comprises an inorganic coating (C) comprising hydrophobic oxide nanoparticles directly adhered to the outer anti-abuse surface of the base layer (B).

The preferred coating (C) of the present film is an inorganic coating, namely a coating comprising major amount of inorganic elements and not including major amount of organic compounds, oligomers, cross-linked or cured polymers, organic networks and the like. Preferably, the coating (C) does not comprise organic compounds, oligomers, cross-linked or cured polymers or organic networks.

Preferably, the coating (C) has a thickness from 0.1 to 5.0 microns, more preferably from 0.2 to 4 microns, more preferably from 1.0 to 2.5 microns.

The hydrophobic oxide nanoparticles of the inorganic coating (C) have an average particle diameter of 3 to 100 nm, preferably 5 to 50 nm, more preferably 5 to 20 nm. The average particle diameter can be measured with a scanning electron microscope (FE-SEM), possibly in combination with an electron microscope such as a transmission electron microscope.

The specific surface area (BET method) of the hydrophobic oxide fine particles is not particularly limited, but is normally 50 to 300 m²/g, preferably 100 to 300 m²/g, measured according to ISO 9277.

The amount of the hydrophobic oxide nanoparticles deposited onto the outer anti-abuse surface of the base layer (B) (grammage after drying) is from 0.01 to 10 g/m², preferably from 0.1 to 2.0 g/m², more preferably from 0.2 to 1.5 g/m².

The hydrophobic oxide nanoparticles are not especially limited as long as they have hydrophobic properties. Accordingly, they may be particles made hydrophobic by suitable surface treatments, such as reactions with silane coupling agents.

Examples of suitable oxides are silica (silicon dioxide), alumina, magnesium oxide, titania or the like, and their admixtures.

Examples of silica include the products Aerosil R972, Aerosil R972V, Aerosil R972CF, Aerosil R974, Aerosil RX200 and Aerosil RY200 (Japan Aerosil) and Aerosil R202, Aerosil R805, Aerosil R812 and Aerosil R812S (Evonik Degussa). Examples of titania include the product Aeroxide TiO2 T805 (Evonik Degussa) and the like.

Examples of alumina include fine particles such as Aeroxide Alu C (Evonik Degussa) made hydrophobic by surface treatment with a silane coupling agent.

Preferably, the hydrophobic oxide is silica, as such or as silica precursor, for instance tetraethyl orthosilicate (TEOS) and the like.

Preferably, highly hydrophobic silica particles having surface trimethylsilyl groups are used.

The coating (C) may additionally comprise other inorganic elements such as zinc and/or magnesium.

The coating (C) confers to the film surface super-hydrophobic properties.

The surface of the present film coated with the coating (C) is characterized by a water contact angle θ higher than 130°, preferably higher than 140°, more preferably higher than 150°, even more preferably higher than 160° measured according to ASTM D7490-13.

Preferably, the coating (C) is a single layer coating but a multilayer coating is also possible.

The film of the present invention is characterized by a total thickness from 7 to 250 microns, preferably from 10 to 200 microns.

The film of the present invention is characterized by a total thickness lower than 250 microns, preferably lower than 200 microns or than 150 microns.

The film of the invention can be oriented at least in one of the longitudinal or transverse (LD/TD) directions, preferably is biaxially oriented, in both directions.

In one embodiment, the film of the invention is not heat-shrinkable. In another embodiment, the film of the invention is heat-shrinkable in at least one of the longitudinal or transverse (LD/TD) directions, preferably in both.

When the film of the invention is heat-shrinkable, it is preferably characterized by a % free shrink in each one of LD and TD direction at 85° C. of at least 10%, preferably at least 15%, even more preferably of at least 20% and a total free shrink at 85° C. of at least 45%, preferably at least 55%, even more preferably at least 60%, measured according to ASTM D2732.

Preferably, the shrink properties of the present film are quite balanced in LD and TD directions, namely the percentages of free shrink measured in LD and in TD at 85° C. do not differ from each other more than 40%, preferably no more than 30%, more preferably no more than 20%.

A second object of the present invention is a process for the manufacture of the super-hydrophobic thermoplastic multilayer packaging film of the first object, which comprises:

i) providing a thermoplastic uncoated optionally heat-shrinkable film (A)/(B), comprising
a thermoplastic heat-sealable layer (A),
a thermoplastic mono or multilayer base layer (B) directly adhered to layer (A),

wherein the surface of the base layer (B) not directly adhered to layer (A) is a rough surface,

ii) applying to the rough surface of the base layer (B) a hydrophobic coating composition,

iii) curing and/or drying the applied hydrophobic coating composition, thus forming a super-hydrophobic coating (C),

wherein the outer surface of the coating (C) not directly adhered to layer (B) has a water contact angle θ measured according to test method ASTM D7490-13 higher than 130°.

The process for the manufacture of the film of the invention first involves providing a thermoplastic uncoated optionally heat-shrinkable film (A)/(B), comprising
a thermoplastic heat-sealable layer (A),
a thermoplastic mono or multilayer base layer (B) directly adhered to layer (A),
   wherein the surface of the base layer (B) not directly adhered to layer (A) is a rough surface (step i)

The uncoated optionally heat-shrinkable film (A)/(B) may be manufactured according to conventional techniques, such as by coextrusion of all the layers, by coextrusion of some layers followed by extrusion-coating or by lamination of the remaining layers, preferably by coextrusion of all the layers.

Preferably, the uncoated film (A)/(B) is manufactured by co-extrusion or extrusion coating, using either a circular or a flat film die that allows shaping the polymer melt into a tubing or a flat film.

Typically, the uncoated film (A)/(B) is co-extruded through a round die to obtain a tubing of molten polymer, which is quenched immediately after extrusion, optionally cross-linked and then optionally oriented. If orientation is performed, the tubing is heated to a temperature, which is above the Tg of all the resins employed and below the melting temperature of at least one of the resins employed, typically by passing it through a hot water bath or heating it with an IR oven or with hot air. The heated tubing is then stretched, still at this temperature, by internal air pressure to get the transversal orientation and longitudinally by a differential speed of the pinch rolls which hold the thus obtained “trapped bubble”.

In some instances it may be desirable to submit the oriented uncoated film (A)/(B) to a controlled heating-cooling treatment (so-called annealing) that is aimed at having a better control on low temperature dimensional stability of the uncoated (A)/(B) heat-shrinkable film.

Otherwise, the uncoated film (A)/(B) may be obtained by flat coextrusion through a slot die, followed by optional cross-linking and optional orientation by heating the flat tape to its softening temperature but below its melt temperature and stretching in the solid state on a simultaneous or a sequential tenterframe. The uncoated film (A)/(B) may be annealed, then rapidly cooled to somehow freeze the molecules of the film in their oriented state and wound.

In case of oriented uncoated film (A)/(B), typical solid state orientation ratios can be from 2:1 to 6:1 in each direction (MD and TD), or from 3:1 to 5:1 in each direction, or from 3.5:1 to 4.5:1 in each direction.

In the uncoated film (A)/(B) the surface of the base layer (B) not directly adhered to the heat-sealable layer (A) is a rough surface, preferably having roughness parameters (Ra, Rq and Rz) as previously defined.

The surface of the base layer (B) may be roughened on the finished film (A)/(B) or at an earlier stage during its manufacture.

The rough surface of the base layer (B) can entrap and immobilize the coating components, resulting in a highly hydrophobic material that is stable, namely that preserves the super-hydrophobicity over time, even if exposed to harsh packaging conditions and possibly to shrinking and/or thermal treatments such as pasteurization or sterilization.

In some embodiments, the surface of the base layer (B) not directly adhered to layer (A) may be roughened by superficial treatments on the finished uncoated film (A)/(B) with mechanical and/or chemical conventional methods known in the art.

In one embodiment, treating the surface of the base layer (B) not directly adhered to layer (A) with mechanical and/or chemical surface treatments comprises the steps of:

a) applying a radiation curable layer comprising acrylate monomers or oligomers onto the surface of the base layer (B) not directly adhered to layer (A), and

b) curing the acrylate monomers or oligomers of the applied layer, preferably by UV, electron beam or infrared radiation.

This process can lead to the formation of a micro-rough surface because of the shrinkage of the radiation-cured layer. Such micro-rough or rough surface, because of its appearance, is here also referred to as a “micro-worms” surface (see FIG. 4A).

The manufacture of “micro-worms” roughened surfaces is known in the art.

The “micro-worms” are generally formed by applying a thin layer of acrylate monomers and/or oligomers to at least one surface of the film; the acrylate monomers and/or oligomers are subsequently crosslinked to form the micro pattern shown in FIG. 4A.

Typically, the protruded portions of the “micro-worms” extend or have a height of about 1 μm when measured with a microscope from the surface of the film where the acrylate monomers/oligomers are applied.

In certain embodiments of the invention, the height of the “micro-worms” is greater than about 0.5 μm, greater than about 1 μm, greater than about 1.5 μm, greater than about 2 μm, and greater than about 2.5 μm.

The acrylate layer may be deposited on the film in the form of a vaporized acrylate monomers and/or oligomers. Following deposition, the acrylate monomers/oligomers are polymerized to form an acrylic polymer. In an embodiment of the invention, the acrylate monomers/oligomers are irradiated, for example with ultraviolet light or an electron beam, to cause polymerization. The acrylate coating which forms as described may thus be substantially a monolithic layer according to certain embodiments of the invention.

Exemplary acrylate resins employed in forming the rough surface layer include monomers or oligomers having an average molecular weight in the range of from 150 to 600 Da. Preferably, the monomers have an average molecular weight in the range of from 250 to 500 Da.

Higher molecular weight acrylates or methacrylates having a high vapor pressure may be equivalent to these lower molecular weight materials and also be used for forming a deposited acrylate layer.

For example, a fluorinated acrylate with a molecular weight of about 2000 Da that has high vapor pressure evaporates and condenses similarly to a non-fluorinated acrylate having a molecular weight in the order of 300 Da. The acceptable range of molecular weights for fluorinated acrylates is about 400 Da to 3000 Da. Fluorinated acrylates include monoacrylates, diacrylates, and methacrylates. Fluorinated acrylates may be preferred due to their fast cure. Methacrylates are generally slower to cure and may be less desirable. Chlorinated acrylates may also be useful.

Exemplary acrylate resins are hexane diol diacrylate, cyclohexane dimethanol diacrylate, polyethylene glycol (200) diacrylate, tripropylene glycol diacrylate, trimethylolpropane triacrylate, tricyclodecane dimethanol diacrylate, propoxylated (2) neopentyl glycol diacrylate.

Acrylates with higher molecular weights may also be used if preheated before being atomized in an evaporation chamber. The pre-heating lowers the viscosity of the liquid and expedites evaporation. The lowered viscosity results in smaller droplets from an atomizer and in enhanced evaporation. This may also permit evaporation of polymers that are solid at ambient temperatures. Either individual monomers or blends of monomers may be preheated. For example, a blend may have a major proportion of monomer with a molecular weight of about 300 Da and a minor proportion of another monomer with a molecular weight in the range of about 800 Da to 1000 Da. Such a monomer blend may be evaporated by preheating before atomizing into the evaporation chamber.

As the acrylate monomers and/or oligomers become polymerized, there tends to be shrinkage in the film. This shrinkage helps in forming the “micro-worms” on the surface of the film. The extent of “micro-worms” that are formed depends, in part, on the nature of the acrylate that is applied to the surface, but also on the degree of crosslink density in the polymerized coating. For instance, if crosslinking radiation is used that partially penetrates the thickness of the acrylate layer, the surface will cure and shrink. The thicker the acrylate layer the higher the peaks and valleys on the micro-worm surface.

The partially cured micro-worm surface can be fully cured at room temperature, or more quickly by heating or by exposing the surface to additional radiation after the “micro-worms” are formed.

In another embodiment of the invention, a micro-rough surface may be formed onto the base layer (B) not directly adhered to layer (A) by using a sputtering process to apply a liquid to the surface, which is subsequently either cooled (thermoplastic operation) or reacted (thermoset operation) to form a hardened micro-rough surface.

In another embodiment, treating the surface of base layer (B) not directly adhered to layer (A) with mechanical and/or chemical surface treatments, comprises hot embossing said surface of the film.

Hot embossing is essentially the stamping of a pattern into a polymer softened by raising the temperature of the polymer just above its glass transition temperature.

The surface of base layer (B) not directly adhered to layer (A) may be roughened by pressing at least one hot roller with a rough metal shim on its surface.

The roughness on the metal shim may be formed by a variety of processes including mechanical abrasion, laser etching and chemical etching.

Radio frequency (RF) heating is an embossing technique known in the art. In a RF process, a die is connected to a high voltage source and the film material or web to be embossed is positioned on a grounded metallic plate and contacts the die. RF generates heat in the film, either directly or indirectly, that softens the material to be embossed near to its melting point. By applying a pressure on the film from the die, an impression is transferred to the film.

Another method for embossing a film involves extruding the film onto a continuously moving, smooth, cooled casting surface (e.g., a chilled roll) where an embossed image is imparted to the extruded film. Such a technique is otherwise known as a slot die-chill cast roll embossing technique. The “roll-to-roll” embossing, which is the most industrially appealing from the economical point of view, commonly uses this method.

Still another method for embossing a film involves the use of a heated engraved embossing roll used in conjunction with a backup roll. The film is passed between the rolls allowing a rough surface to be formed on the film. The use of this technique requires that the film be heated sufficiently to take a deep and permanent embossed pattern from the image on the embossing roll. This method is commonly used in the “roll-to-roll” embossing too.

Still another method for embossing a film involves the use of a movable embossing element equipped with a plurality of male dies capable of transferring heat and the male image to the film. Another embossing element having a plurality of female dies is additionally used in tandem with this technique. The unheated female die is aligned with the heated element equipped with the male dies to form the rough image on the film.

In certain embodiments of the invention, the rough surface includes embossed holes, embossed pillars, or a combination thereof.

FIG. 4B is a surface view of an embossed uncoated film A/B, having 2 μm holes, precursor of a film according to an embodiment of the invention.

FIG. 4C is a surface view of an embossed uncoated film A/B, having 1 μm holes, precursor of a film according to another embodiment of the invention.

FIG. 4D is a surface view of an embossed uncoated film A/B having 200 nm holes precursor of a film according to still another embodiment of the invention.

FIG. 4E is a surface view of an embossed uncoated film, having 200 nm pillars, precursor of a film according to still yet another embodiment of the invention.

In an embodiment of the invention, the embossed holes in the surface of the base layer (B) not directly adhered to layer (A) are less than about 2 μm, less than about 1.5 μm or, preferably, less than about 1 μm in mean diameter size. In an embodiment of the invention, the embossed pillars in the surface of the base layer (B) not directly adhered to layer (A) are less than about 2 μm, less than about 1.5 μm or, preferably, less than about 1 μm in in mean diameter size.

In another embodiment, treating the surface of base layer (B) not directly adhered to layer (A) with mechanical and/or chemical surface treatments, comprises micro embossing said surface.

The (A)/(B) uncoated film may be pre-heated and passed through nip rollers with one nip roller shaped to induce a roughness on the surface of the film. Pressure and heat are applied to the film as it passes through the nip rollers in order to impart the micro-roughness to the surface of the film.

In another embodiment, treating the surface of base layer (B) not directly adhered to layer (A) with mechanical and/or chemical surface treatments comprises imparting indentations and/or scratches on said surface.

Indentations and/or scratches may be imparted on said surface by mechanical means such as a rotating brush with various types of bristles to obtain a micro-rough surface.

Methods for roughening a film surface include brushing the surface with brushes that comprise metal, polymer and composite bristles of various sizes and shapes.

A micro-roughened surface may be either uniform or non-uniform in its pattern.

In an embodiment, a chemical-mechanical polishing step using a slurry that leaves small indentations in a surface of the film may be used to form a micro-rough surface. The characteristics of the size of the particles in the slurry, the extent of polishing, and the method in which the polishing is carried out will be determinative of the density of roughness imparted to the surface, the depth of micro-scratch regions in the surface, and the uniformity or lack thereof, of micro-roughness imparted to the surface.

In another embodiment, treating the surface of base layer (B) not directly adhered to layer (A) with mechanical and/or chemical surface treatments comprises nano-imprint lithography (NIL).

In a typical NIL process, a thin layer of imprint resist (thermoplastic polymer) is spin coated onto the surface of the film. Then the mold, which has predefined topological patterns, is brought into contact with the sample and they are pressed together under certain pressure. When heated up above the glass transition temperature of the polymer, the pattern on the mold is pressed into the softened polymer film. After being cooled down, the mold is separated from the sample and the pattern resist is left on the film.

In another embodiment, treating the surface of base layer (B) not directly adhered to layer (A) with mechanical and/or chemical surface treatments comprises subjecting the surface of the film to an energetic radiation in the presence of oxygen. Suitable energetic radiation treatments include corona discharge, flame, plasma, ultraviolet and electron beam radiation.

Advantageously, the roughening methods that do not use curable monomers or oligomers may be more easily approved by regulatory authorities for use in food packaging. In fact, these methods do not introduce on the film surface reactive species that, if not properly cured, may be possibly released.

Advantageously, the roughening methods that do not require cross-linking of curable monomers or oligomers generally provide for sealing surfaces that are sealable at lower temperatures and/or shorter time than those of cured sealing surfaces.

The surface of the base layer (B) not directly adhered to layer (A) may be roughened at an earlier stage during the manufacture of the (A)/(B) film, in particular by incorporating the micro-particles as previously defined in the base layer (B) at coextrusion.

Preferred roughening methods are incorporation of micro-particles and microembossing, most preferred the incorporation of micro-particles as previously defined.

The process for the manufacture of the film of the invention further comprises applying to the rough surface of the base layer (B) not directly adhered to layer (A) a hydrophobic coating composition (step ii).

The application of the hydrophobic coating composition to the rough surface of the base layer (B) not directly adhered to layer (A) may be performed by any standard coating method, such as for instance by gravure coating, smooth roll coating, direct gravure, reverse gravure, offset gravure, spray coating or dip coating.

As an alternative, the coating may be applied by vacuum deposition.

FIG. 6 is a block diagram of a process for applying a thin layer of a coating to a film by vacuum deposition.

In this process, vacuum deposition may be used to apply the acrylate—which after curing provides the roughening of the film surface according to an embodiment previously described (micro-worms)—and/or the hydrophobic coating composition.

The vacuum deposition apparatus 10 of FIG. 6 includes a Degas vessel 20 for holding the liquid hydrophobic coating composition to be applied to a film 60. The liquid hydrophobic coating composition is conveyed from the Degas vessel 20 to an evaporation chamber 30 where the liquid hydrophobic coating composition is flash evaporated to above its boiling point. The vapor is then directed from the evaporation chamber 30 to a deposition apparatus 40. The deposition apparatus 40 includes a deposition nozzle 50 for applying the hydrophobic coating composition to the surface of the film 60 under vacuum. The film 60 has an uncoated region 70 and a coated region 80 formed on the film 60 after the vacuum deposition has occurred at the deposition nozzle 50. The uncoated film 70 may pass over a cold roll 90 before or during the vapor deposition to facilitate the monomer condensation process and an efficient conversion of the vapor into a liquid layer. Additionally, if the hydrophobic coating composition is an acrylate designed to produce a micro-worm surface, the coated film passes in front of a radiation-curing device 100. For example, in certain embodiments of the invention, the curing device 100 comprises electron beam radiation.

The film 60 used in this coating step is the uncoated thermoplastic film (A)/(B) described above, having the surface of the base layer (B) not directly adhered to layer (A) roughened, preferably due to the micro-particles incorporated into the base layer (B).

Flash evaporation of the liquid may occur in the evaporation chamber 30. In flash evaporation, the liquid is introduced into a heated chamber 30 under an elevated temperature, which causes the liquid to evaporate instantly. The deposition rate and the coating thickness can be accurately controlled by the rate at which the liquid is fed into the evaporation chamber.

The film to be coated 60 is handled by a conventional roll-to-roll process where the film is unwound from a pay-out reel and rewound into a roll after the coating process. The amount of the hydrophobic coating composition applied to the rough surface of the base layer (B) not directly adhered to layer (A) of the uncoated thermoplastic film (A)/(B) generally ranges from 4 to 50 g/m² (wet grammage).

The hydrophobic coating composition suitable to be applied to the rough surface of the base layer (B) of the uncoated thermoplastic film (A)/(B) may be any conventional composition commonly known for its ability to form hydrophobic coatings, providing that it is compatible with the specific application on thermoplastic packaging films.

Typically the hydrophobic coating composition comprises one or more hydrophobic components such as for instance fluoropolymers, polysiloxanes, hydrophobic nanoparticles, such the hydrophobic oxides previously mentioned, in particular silica and silica precursors as tetraethyl orthosilicate (TEOS) and the like, super-hydrophobic waxes.

Optionally, the hydrophobic coating composition may comprise a solvent, a binder or adhesion promoter or other adjuvants as known in the art.

Preferably, the hydrophobic coating composition may comprise hydrophobic oxide(s) as previously defined in a content from 10 to 100 g/l.

Upon deposition, curing and/or drying, the hydrophobic coating composition forms a thin layer of hydrophobic material on the rough surface, namely the hydrophobic coating (C).

The surface so roughened and coated is characterized by a water contact angle θ higher than 130° measured according to test method ASTM D7490-13.

A preferred hydrophobic coating composition suitable to impart super-hydrophobic properties to the uncoated thermoplastic film (A)/(B) is a liquid dispersion, which upon deposition and subsequent drying, forms a nano-structured coating (C).

Preferably, the coating composition is a dispersion of one or more of the hydrophobic oxides previously mentioned, more preferably a dispersion of silica, alumina, titania, optionally made hydrophobic by reaction with silane coupling agents, or their admixtures.

Preferably, the coating composition further comprises other inorganic elements such as zinc or magnesium.

The coating composition preferably does not include organic film forming polymers or curable polymers.

The solvent of the preferred coating composition may be water or an organic solvent such as alcohol, cyclohexane, toluene, acetone, ethyl acetate, propylene glycol, hexylene glycol, butyl diglycol, pentamethylene glycol, normal pentane, normal hexane, hexyl alcohol or the like.

Preferably, the solvent of the coating composition is water, an alcohol or admixture thereof, more preferably, water, iso-propanol, ethanol, methanol or their admixtures. Additives such as dispersant, colorant, anti-settling agent, viscosity adjuster or the like can also be included.

The amount of the hydrophobic oxide(s) in the coating composition generally ranges from about 10 to 100 g/l.

The process for the manufacture of the film of the invention further comprises curing and/or drying the applied hydrophobic coating composition (step iii) thus forming a super-hydrophobic coating (C).

Any suitable conventional curing method may be used to harden the applied coating. Preferably, the coated film is dried by air evaporation or preferably by passing it into a hot air oven or in other conventional ovens (e.g. IR heated ovens), typically set at temperatures lower than 150° C., preferably from 80 to 120° C.

The resulting dried coating (C) generally has a thickness from 0.1 to 5.0 microns, preferably from 0.2 to 4 microns, more preferably from 0.3 to 2.0 microns.

In certain embodiments of the invention, the roughened surface may be subjected to more than one coating deposition. In these embodiments, coatings comprising the same or different super-hydrophobic compounds may be deposited sequentially. A third object of the present invention is a flexible optionally shrinkable article for packaging, in the form of a seamless tubing or of a flexible container, having at least an opening for introducing a product, the article being made from a film according to the first object, wherein the outermost surface of the article- namely the outer abuse resistant surface of the article—is the super-hydrophobic surface of coating (C) having a water contact angle θ measured according to test method ASTM D7490-13 higher than 130°.

Preferably, the article is used for food packaging.

Advantageously, this flexible article provides for packages that, when subjected to conventional thermal treatments for the reduction of the bacterial load of the packaged products through hot water or steam (e.g. pasteurization, sterilization), do not need any further drying step.

Similarly, when the flexible article is made from a heat-shrinkable film, it provides for packages that, when heat shrunk around the product by submersion in a conventional hot water bath or by passing through a hot water shower, do not need any further drying step.

In fact, the super-hydrophobic surface makes the water droplets slip away from the packages and provides for dry packages. The elimination of the drying step in the shrinking process and/or in the pasteurization or sterilization processes results in significant savings in terms of time, equipment and, overall, of costs.

The article for packaging may be a seamless tubing or a flexible container such as a pouch or a bag, having at least an opening for introducing a product and made from the film according to the invention.

In the article for packaging according to the present invention, the coating (C) is the outermost layer of the article.

Conventional manufacturing processes can be used to manufacture the article for packaging according to the present invention.

In one embodiment, the article for packaging is a seamless tubing having the super-hydrophobic surface as the outermost surface of the tubing.

The seamless tubing may be manufactured by coextrusion or extrusion coating through a round die of the layers of the present films as previously defined, optionally followed by irradiation and/or trapped bubble orientation and, possibly, annealing, as described above.

The resulting seamless tubing can be directly processed to provide flexible packaging containers or, in alternative, can be converted to a flat film by slitting before being winded into rolls or being further re-processed.

In one embodiment, the flexible container according to the present invention is a pouch.

Preferably, the thickness of the film in a pouch according to the present invention is from 50 to 150 microns.

In one embodiment, the pouch is non-heat-shrinkable.

In one embodiment, the pouch is heat-shrinkable.

In one embodiment, the pouch is heat-shrinkable and gas-barrier.

The pouch according to the invention may be manufactured by folding, self-sealing and severing a film according to the invention.

The heat-sealing of the film to itself according to the present invention may be accomplished in a fin-seal and/or lap-seal mode.

In the fin-seal mode, two outer coated heat-sealable surfaces are faced and sealed together (i.e. a first outer heat-sealable surface faces another first outer heat-sealable surface).

In the lap-seal mode, the first outer heat-sealable surface is sealed onto the second outer coated surface of the film (i.e. the first outer heat-sealable surface of the film overlaps the second outer coated surface of the film).

The pouch according to the invention may comprise two or three seals and an opening to insert the product.

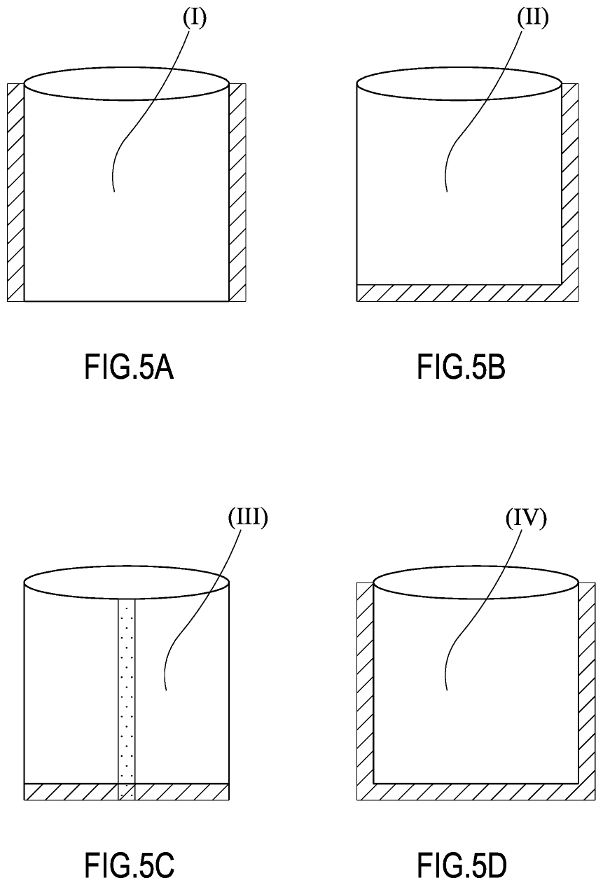

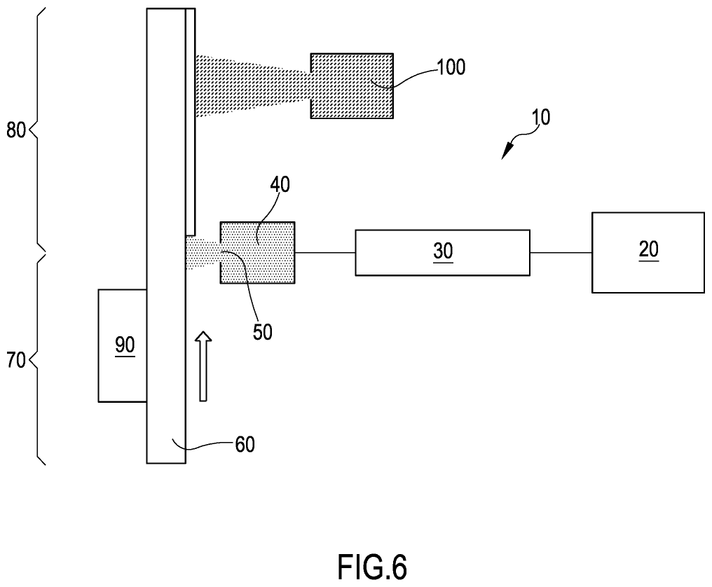

FIG. 5A-5D illustrate a few embodiments of the present pouches.

In one embodiment (I), the pouch comprises a top opening, two fin-sealed sides and a folded bottom (FIG. 5A).

In one embodiment (II), the pouch comprises a top opening, one folded side, one fin-sealed side and a fin-sealed bottom (FIG. 5B).

In one embodiment (III), the pouch comprises a top opening, two folded sides, one central longitudinal lap-seal and a fin-sealed bottom (FIG. 5C).

In one embodiment (IV), the pouch comprises a top opening, two fin-sealed sides and a fin-sealed bottom (FIG. 5D).

The pouch according to the invention may be manufactured starting from a film (embodiments I-III) or from two coupled films (embodiment IV) unwounded from a roll or, in case of two films, possibly from two separated rolls, according to known methods.

Otherwise, the pouch according to the invention may be manufactured starting from one (embodiments I-III) or two (embodiment IV) pre-cut pieces of the film of the invention, according to known methods.

The pouch according to the invention may be a pre-made pouch manufactured by conventional folding, sealing and cutting operations of the starting film(s) or of the starting pre-cut piece(s) of film, as known in the art.

Alternatively, the pouch according to the invention may be manufactured, directly filled in with the product and closed in-line, according to known form-fill-seal methods, such as the HFFS (horizontal form fill seal) method.

In one embodiment, the flexible container according to the present invention is a bag.

Preferably, the thickness of the film in a bag according to the present invention is from 35 to 90 microns.

In one embodiment, the bag is non-heat-shrinkable.

In one embodiment, the bag is heat-shrinkable.

In one embodiment, the bag is heat-shrinkable and gas-barrier.

The bag according to the invention may be manufactured by folding, self-sealing and severing a film according to the invention.

The heat-sealing of the film to itself according to the present invention may be accomplished in a fin-seal and/or lap-seal mode as previously explained.

The bag according to the present invention may be for instance an end-seal bag, a side-seal bag, a L-seal bags or a U-seal bag.

In one embodiment, the bag is an end-seal bag made from a seamless tubing, the end-seal bag having an open top, first and second folded side edges, and an end seal across the bottom of the bag.

In one embodiment, the bag is a side-seal bag having an open top, a folded bottom edge, and first and second side seals.

Other bag and pouch making methods known in the art may be readily adapted to make flexible containers from the multilayer film according to the present invention.

A fourth object of the present invention is a hermetic, optionally vacuum shrunk package in which the film of the first object or the article of the third object hermetically enclose a product, wherein the outermost surface of the package is the super-hydrophobic surface of the coating (C), said surface having a water contact angle θ measured according to test method ASTM D7490-13 higher than 130°.

In one embodiment of the present package, the article for packaging is a pouch, preferably a gas-barrier pouch. In one embodiment, the package is a shrinkable pouch.

As mentioned above, a common method of packaging food and non-food products is by means of pouches made on form-fill-seal machines, such as a Horizontal Form-Fill-Seal (HFFS) or a Vertical Form-Fill Seal (VFFS) machine, preferably on HFFS machines.

In one embodiment of the present package, the article for packaging is a bag, preferably a gas-barrier bag. In one embodiment, the package is a shrinkable bag. In a conventional packaging process the bag made of the film of the invention is typically loaded with the product, evacuated, and then closed at the open end by heat-sealing. This process is advantageously carried out within a vacuum chamber where evacuation and heat sealing are done automatically.

Typically, the pressure in the vacuum chamber may range from 3 to 30 mBar, according to the food product to be packaged. Common pressure values in the vacuum chamber are 5 to 10 mBar.

After the bag is removed from the chamber, it can optionally be heat shrunk by applying heat. Shrinking may be carried out, for instance, by submerging the filled bag into a hot water bath or conveying it through a hot water shower. The heat treatment will produce a tight wrapping that will closely conform to the contour of the product therein packaged. Advantageously, at the exit of the shrinking apparatus, the shrunk bag according to the invention is dry.

Alternatively or additionally, the bag can undergo a thermal treatment to decrease the microbial load of the packaged product. Common thermal treatments are pasteurization and sterilization. Pasteurization generally is performed by exposing the package to steam or to a hot water bath or shower at a temperature lower than 100° C. for a time variable according to the type of product and to the desired reduction of bacterial load. One common way to sterilize products is through heat and humidity, typically using an autoclave.

The present package optionally comprises at least one tear initiator for an easy opening.

A bag from a film of the invention has wide applications, preferably for food packaging. Heat shrinkable, preferably gas barrier bags from a film of the invention are preferred for packaging meat, beef meat, poultry, cheese, fish, processed or smoked meat, pork and lamb. The shrink properties of the film will in fact guarantee a complete shrinkage of the bag around the product, so that the bag is not wrinkled, thus offering an attractive package. The bag will have proper abuse resistance in order to physically survive the process of being filled, evacuated, sealed, closed, optionally heat shrunk, boxed, shipped, unloaded, and stored at the retail supermarket, and a sufficient stiffness to improve also its loading process.

Non-heat shrinkable bags or pouches from a film of the invention can conveniently be used to package food or beverages requiring a sterilization or pasteurization process such as, e.g., fluids like sauces, baby food, wine, beer, milk, fruit juices. The present invention is further illustrated by the following Examples.

### EXAMPLES

The following resins were used in the manufacture of the films:

TABLE 1

| Tradename | Supplier | Acronym |
|---|---|---|
| EXCEED 4518PA | ExxonMobil | LLDPE1 |
| Surpass FPs417-A | NOVA Chemicals | LLDPE2 |
| EXCEED 1012MA | ExxonMobil | LLDPE3 |
| 10,075ACP Syloid Concentrate | Teknor Color | LDPE1 |
| LD-102.74 | ExxonMobil | LDPE2 |
| ELVAX 3165 | DuPont | EVA1 |
| BYNEL 4125 | DuPont | LLDPE-md1 |
| GT4408 | Westlake | LLDPE-md2 |
| | Chemicals | |
| Aegis H155ZP | AdvanSix | PA-6 |
| E171B | EVALCA/Kuraray | EVOH/EVAL1 |
| Eval H171B | EVALCA/Kuraray | EVOH/EVAL2 |
| T60-500-119 | Ineos | HDPE |
| Spheriglass 3000 | Potters Industries | Glass micro- |
| | | particles |

wherein

LLDPE1: Density 0.9180 g/cc, Melt Flow Rate (190° C./2.16 kg) 4.50 g/10 min, Melting point 114.0° C.

LLDPE2: Density 0.917 g/cc, Melt Flow Rate (190° C./2.16 kg) 4.50 g/10 min

LLDPE3: Density 0.912 g/cc, Melt Flow Rate (190° C./2.16 kg) 1.00 g/10 min

LDPE1: Antiblock resin, Ash 9.2%, Density 0.97 g/cc, Melt Flow Rate (190° C./2.16 kg) 3.00 g/10 min, Moisture Content Max 0.20%

LDPE2: antiblock resin Ash 2.40%, Density 0.92 g/cc, Melt Flow Rate (190° C./2.16 kg) 6.5 g/10 min, Melting point 110° C.

EVA1: Comonomer content (Vinyl Acetate) 18%, Density 0.940 g/cc, Melt Flow Rate (190° C./2.16 kg).0.70 g/10 min, Melting point 87.0° C., Moisture Content Max 0.3%, Vicat softening point 69.0° C.

LLDPE-md1: Comonomer content (Maleic Anhydride) Min 0.09 Max 0.15%, Density 0.930 g/cc, Melt Flow Rate (190° C./02.16 kg). 2.50g/10 min, Melting point 126.0° C., Vicat softening point 109° C.

LLDPE-md2: Density 0.919 g/cc, Melt Flow Rate (190° C./02.16 kg). 2.3 g/10 min, Melting point 122.0° C.

PA-6: Density 1.130 g/cc, Melting point 220° C., Viscosity relative 155

EVOH/EVAL1: Comonomer content 44%, Crystallization point 144° C., Density 1.14 g/cc, Glass Transition 54° C., Melt Flow Rate (190° C./02.16 kg) 1.7 g/10 min, Melting point 165° C., Vicat softening point 152° C.

EVOH/EVAL2: Comonomer content 38%, Crystallization point 148° C., Density 1.17 g/cc, Glass Transition 53° C., Melt Flow Rate (190° C./02.16 kg) 1.7 g/10 min, Melting point 172° C.

HDPE: Density 0.961 g/cc, Melt Flow Rate (190° C./02.16 kg). 6.20g/10 min, melting point 135.0° C.

Glass micro-particles: Solid glass microspheres, average particle size: 30-50 μm.

Tapped bulk density: 1.59 g/cc.

Film Structures

The following films were manufactured:

TABLE 2
multilayer films

| | Comparative film C1 | Comparative film C2 | Ex. 1 Invention |
|---|---|---|---|
| Layer | (no coating, no micro-particles) | (no coating, micro-particles) | (coating, micro-particles) |
| C | — | — | Super-hydrophobic |
| | | | coating |
| B | LLDPE1 95% | LLDPE1 95% | LLDPE1 95% |
| | LDPE1 5% | LDPE1 5% | LDPE1 5% |
| | (15 mic) | (15 mic) | (15 mic) |
| | EVA1 100% | LLDPE1 75% | LLDPE1 75% |
| | (15 mic) | Glass micro-particles 25% | Glass micro-particles 25% |
| | | (15 mic) | (15 mic) |
| | EVA1 100% | EVA1 100% | EVA1 100% |
| | (7 mic) | (7 mic) | (7 mic) |
| | LLDPE-md1 100% | LLDPE-md1 100% | LLDPE-md1 100% |
| | (10 mic) | (10 mic) | (10 mic) |
| | EVOH/EVAL1 100% | EVOH/EVAL1 100% | EVOH/EVAL1 100% |
| | (12 mic) | (12 mic) | (12 mic) |
| | LLDPE-md1 100% | LLDPE-md1 100% | LLDPE-md1 100% |
| | (10 mic) | (10 mic) | (10 mic) |
| | EVA1 100% | EVA1 100% | EVA1 100% |
| | (22 mic) | (22 mic) | (22 mic) |
| A | HDPE 95% | HDPE 95% | HDPE 95% |
| | LDPE15% | LDPE15% | LDPE1 5% |
| | (9 mic) | (9 mic) | (9 mic) |
| Total | 100 mic. | 100 mic | 100 mic |
| Thickness | | | |

| | Comparative film C3 | Ex. 2 Invention |
|---|---|---|
| Layer | (no coating, micro-particles) | (coating, micro-particles) |
| C | — | Super-hydrophobic coating |
| B | LLDPE1 75% | LLDPE1 75% |
| | Glass micro-particles 25% | Glass micro-particles 25% |
| | (15 mic) | (15 mic) |
| | EVA1 100% | EVA1 100% |
| | (15 mic) | (15 mic) |
| | EVA1 100% | EVA1 100% |
| | (7 mic) | (7 mic) |
| | LLDPE-md1 100% | LLDPE-md1 100% |
| | (10 mic) | (10 mic) |
| | EVOH/EVAL1 100% | EVOH/EVAL1 100% |
| | (12 mic) | (12 mic) |
| | LLDPE-md1 100% | LLDPE-md1 100% |
| | (10 mic) | (10 mic) |
| | EVA1 100% | EVA1 100% |
| | (22 mic) | (22 mic) |
| A | HDPE 95% | HDPE 95% |
| | LDPE15% | LDPE1 5% |
| | (9 mic) | (9 mic) |
| Total | 100 mic | 100 mic |
| Thickness | | |
| | Ex. 3 Invention | Ex. 4 Invention |
| Layer | (coating, micro-particles) | (coating, microparticles) |
| C | Super-hydrophobic coating | Super-hydrophobic coating |
| B | LLDPE2 70% | LLDPE1 75% |
| | LDPE2 30% | Glass microparticles 25% |
| | (9.8 mic) | (9.8 mic) |
| | LLDPE3 70% | LLDPE2 70% |
| | Glass microparticles 25% | LDPE2 30% |
| | (14 mic) | (14 mic) |
| | LLDPE-md2 100% | LLDPE-md2 100% |
| | (9.8 mic) | (9.8 mic) |
| | PA-6 100% | PA-6 100% |
| | (18.2 mic) | (18.2 mic) |
| | EVOH/EVAL2 100% | EVOH/EVAL2 100% |
| | (14 mic) | (14 mic) |
| | PA-6 100% | PA-6 100% |
| | (18.2 mic) | (18.2 mic) |
| | LLDPE-md2 100% | LLDPE-md2 100% |
| | (9.8 mic) | (9.8 mic) |
| | LLDPE2 70% | LLDPE2 70% |
| | LDPE2 30% | LDPE2 30% |
| | (39.1 mic) | (39.1 mic) |
| A | LLDPE2 70% | LLDPE2 70% |
| | LDPE2 30% | LDPE2 30% |
| | (7 mic) | (7 mic) |
| Total | 139.9 mic | 139.9 mic |
| Thickness | | |

The comparative film C1 represents a conventional uncoated film, not comprising micro-particles. It was manufactured on a downward round cast line. The selected resins were extruded, at a die temperature of 210° C. The melt coming out of the round die in a form of a tube was quenched using a water ring (water temperature about 10° C.). The quenched tube was pulled by a couple of pinch rolls, which also pressed it to form the so called tape. The tape was cross-linked at approx. 65 kGy and finally oriented. It was initially heated up by passing through a hot water bath io (set at 93° C.), and then oriented using stretching ratios of about 3.2:1 in both longitudinal and transversal directions. The orientation was carried out by double-bubble methodology. The bubble was cooled down using an air ring (air temperature set at 20° C.), pulled by a couple of deflates rolls, and wound in the form of a tubing in the finished roll. The free shrink %, measured (at 85° C., 3 sec of immersion in water) was 32% in the L direction, and 38% in the T direction.

The comparative films C2 and C3 were prepared in a manner similar to C1, but, at extrusion, glass micro-particles were incorporated in the layer indicated in Table 2, in order to impart surface roughness.

The uncoated films C2 and C3 were then coated by applying an inorganic hydrophobic coating composition thus obtaining, after drying, the corresponding coated film of the invention of Ex.1 and 2, respectively.

The inorganic hydrophobic coating composition was prepared by dispersing 5 g of io hydrophobic oxide nanoparticles (Aerosil R812S (Evonik Degussa), BET specific surface area 220 m²/g, average primary particle diameter 7 nm) in 100 ml ethanol. The hydrophobic coating composition was applied by a standard gravure coating process on a conventional equipment. Process application and drying conditions were: machine speed: 120 m/min; coating roll: gravure roll, having 50 lines/cm; coating composition weight: about 15 g/m² (wet grammage), oven drying temperature: 90° C. The final coating was about 0.5 microns thick, with a dry weight of about 0.3 g/m².

The films of Ex. 3 and Ex. 4 are high abuse resistant films, comprising two polyamide layers. Both films were prepared by coextrusion as described above, incorporating glass microparticles in the layer indicated in Table 2, in order to impart surface roughness. After coextrusion, the inorganic hydrophobic coating composition described above was applied by a standard gravure coating process on a conventional equipment, in the same conditions as described above.

Film Properties

The comparative films and the film of the invention were characterized according to the following tests.

Shrink Properties

The free shrink % of the films was measured at 85° C. according to ASTM D2732.

Scanning Electron Microscopy (SEM)

In order to investigate the morphology of the rough surfaces of film samples, environmental scanning electron microscopy (ESEM) analysis was carried out by means of a Quanta 200 (FEI, USA).

Roughness

Roughness was measured for the coated films of Ex. 3 and Ex. 4. The roughened surface of the coated film of Ex. 3 is characterized by a Mean Roughness (Roughness Average Ra) of about 0.35 μm, by a Root Mean Square (RMS) roughness (Rq) of about 0.42 μm and by a Mean Roughness Depth (Rz) of about 2.96 μm, measured according to ISO4287.

The film of Ex. 4, where the microparticles are in the outermost layer of the film (i.e. the layer adjacent to the coating), as expected has greater roughness values, namely a Mean Roughness (Roughness Average Ra) of about 0.54 μm, a Root Mean Square (RMS) roughness (Rq) of about 0.65 μm and a Mean Roughness Depth (Rz) of about 4.48 μm, measured according to ISO4287.

Water Contact Angle θ

The static water contact angle θ of the above films was measured according to ASTM D7490-13.

Contact angles were measured for comparative films C1, C2, and for the films of the invention of Ex. 1 and 2. Contact angles θ were measured on the outermost anti-abuse surface, which is uncoated in C1 and C2 and coated with the super-hydrophobic coating in Examples 1 and 2.

The results are collected in the following Table 3:

TABLE 3

| Film | Roughened surface | Coating | Water contact angle θ (°) |
|---|---|---|---|
| C1 | No | No | 81.4 |
| C2 | Yes | No | 72.6 |
| Ex. 1 | Yes | Yes | >160° |
| EX. 2 | Yes | Yes | >160° |

As can be seen, the water contact angle θ of the comparative uncoated film C1 was 81.4° while a lower value of 72.6° was measured for the comparative uncoated film that incorporated micro-particles (C2). These values lower than 90° are typical of hydrophilic wettable surfaces.

On the contrary, the coated surfaces of the films of the invention of Ex. 1 and 2 showed very high contact angles in line with the low wettability shown by these surfaces. The Water contact angles θ of the coated furfaces of the films of the invention of Ex. 3 and Ex. 4 were in line with those of Ex. 1 and Ex. 2.

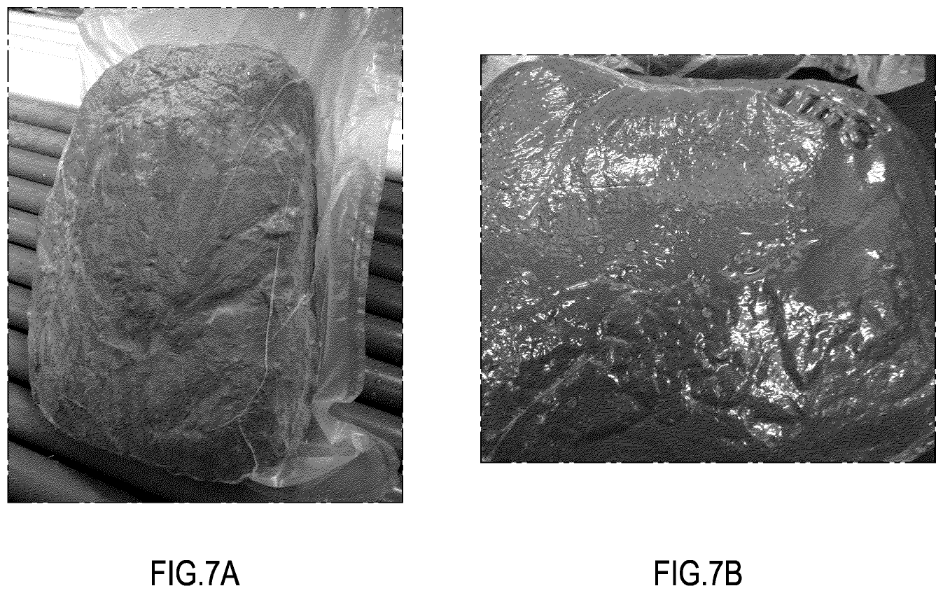

These super-hydrophobic surfaces, when in the packaging cycle exited the hot water shrinking equipment, resulted completely dry as described in the following tests and as shown in the picture of FIG. 7A.

Water Shower Test

This is a very quick qualitative test useful for a preliminary screening of the films. Samples of the comparative films C1 and C2 and of the films according to the invention Ex.1-Ex. 2, were subjected to a water shower for 10 seconds. After the shower, the samples according to the invention were perfectly dry on the coated surface while droplets of water covered the samples made from the comparative films.

Manufacture of Vacuum Shrunk Packages

The comparative film C1 and the film according to the invention of Ex. 1 were used to package rubber round dummies in vacuum shrink bags. In the final packages, the super-hydrophobic surface (C) was the external surface of the bag while the heat sealable surface (A) was the internal surface of the bag, directly in contact with the product.

Five bags (dimensions: 230 mm×400 mm) for each film were manufactured in a conventional packaging cycle including vacuumization, sealing and final shrinking of the package in a shrink tunnel at 85° C. (packaging equipment: CRYOVAC VS20 machine; vacuum: 5 mBar; sealing time: 1.5 sec, cooling time: 2 sec; seal setting: Ultraseal 310 at 170° C., shrink tunnel: ST90 Cryovac, shrinking time: 3-5 sec.).

At the exit of the shrink tunnel, the outer surface of each bag was dried by dabbing with absorbent paper. After dabbing, the wet papers were weighted and the amount of collected water was calculated by subtracting the initial weight of the papers. The grams of water collected from each bag after passage into the shrink tunnel are reported in the following Table 4:

TABLE 4
grams of water

| | Film C1 | Film Ex. 1 |
|---|---|---|
| Bag n. | (Comp.) | (Inv.) |
| 1 | 3 | 0 |
| 2 | 3 | 0 |
| 3 | 3 | 1 |
| 4 | 2 | 0 |
| 5 | 3 | 1 |

The data reported in Table 4 clearly demonstrate that the super-hydrophobic surface of the film of the invention was effective in repelling water.

The pictures of FIGS. 7A and 7B show that at the exit of the water shrink tunnel a bag made from the comparative film C1 was covered with water droplets. On the contrary, the bag made from the film of the invention of Ex. 1 was perfectly dry.

The five packages manufactured above with the film of the invention of Ex. 1 were stored at 5° C. and kept under observation for 1 week: after this time, all the packages maintained the initial vacuum tight appearance thus confirming the preservation of hermeticity.

In conclusion, the data and the observations reported above demonstrate that the film according to the invention, even if subjected to rather demanding packaging conditions, preserves the super-hydrophobic performance and allows to remarkably reduce or eliminate water from the external surface of bags made from this film exiting the shrink tunnel.

Accordingly, no drying step is needed and the packaged products can be shipped after shrinking as such, even in cardboard boxes. Drying devices such as fans or air blades are no longer needed, thus saving energy and room in the packaging plant.

Machinability

Mill logs of the coated film of Ex. 3 and Ex 4 according to the invention were slit into 510 mm wide rolls on a Dusenbery slitter. The slit rolls were visually inspected and their quality resulted good in terms of planarity and edge profile. The slit rolls were then tested on an Onpack 2070 equipment to check their machinability: both coated films ran well.

The presence of the hydrophobic coating therefore does not affect negatively the machinability of the films.

1. A super-hydrophobic thermoplastic multilayer packaging film comprising:
an outer thermoplastic heat-sealable layer (A),
an inner thermoplastic mono or multilayer base layer (B) directly adhered to layer (A),
an outer super-hydrophobic coating (C) directly adhered to layer (B),
wherein the surface of the base layer (B) directly adhered to the coating (C) is a rough surface and the outer surface of the coating (C) not directly adhered to layer (B), has a water contact angle θ measured according to test method ASTM D7490-13 higher than 130°.

2. The film according to claim 1 wherein the outer thermoplastic heat-sealable layer (A) comprises a major amount of a polymer selected among ethylene-vinyl acetate copolymers (EVA), polyethylenes, homogeneous or heterogeneous, linear ethylene-alpha-olefin copolymers, polypropylene copolymers (PP), ethylene-propylene copolymers (EPC), acrylates and methacrylates, ionomers, polyesters and their blends.

3. The film according to claim 1 wherein the inner thermoplastic base layer (B) comprises an inner gas barrier layer (F) and, optionally, one or more additional layers.

4. The film according to claim 1 wherein the inner thermoplastic mono or multilayer base layer (B) comprises micro-particles.

5. The film according to claim 4 wherein the micro-particles have an average particle diameter from 0.5 to 100 microns.

6. The film according to claim 4 wherein the micro-particles are selected from acrylic micro-particles and glass micro-particles.

7. The film according to claim 1 wherein the outer super-hydrophobic coating (C) comprises one or more organic or inorganic hydrophobic components selected among fluoropolymers, polysiloxanes, hydrophobic nanoparticles, waxes, preferably among hydrophobic oxide nanoparticles, silica, alumina, magnesium oxide, titania micro-particles and their admixtures.

8. The film according to claim 7 wherein the hydrophobic oxide nanoparticles of the inorganic coating (C) have an average particle diameter of 3 to 100 nm.

9. The film according to claim 7 wherein the amount of hydrophobic oxide nanoparticles in the coating (C) deposited onto the outer surface of the base layer (B) is from 0.01 to 10 g/m² (grammage after drying).

10. The film according to claim 1 wherein the outer surface of the coating (C) is characterized by a Mean Roughness (Roughness Average) Ra higher than 0.32 μm, by a Root Mean Square (RMS) roughness Rq higher than 0.39 μm and/or by a Mean Roughness Depth Rz higher than 2.42 μm, measured according to ISO4287.

11. The film according to claim 1 wherein the outer surface of the coating (C) not directly adhered to layer (B), has a water contact angle θ measured according to test method ASTM D7490-13 higher than 150°.

12. The film according to claim 1, wherein said film is heat-shrinkable.

13. The film according to claim 12 characterized by a total % free shrink at 85° C. measured according to ASTM D2732.

14. A process for the manufacture of a super-hydrophobic thermoplastic multilayer packaging film comprising:
an outer thermoplastic heat-sealable layer (A),
an inner thermoplastic mono or multilayer base layer (B) directly adhered to layer (A),
an outer super-hydrophobic coating (C) directly adhered to layer (B),
wherein the surface of the base layer (B) directly adhered to the coating (C) is a rough surface and the outer surface of the coating (C) not directly adhered to layer (B), has a water contact angle θ measured according to test method ASTM D7490-13 higher than 130°,
the process comprising the steps of:
i) providing a thermoplastic uncoated optionally heat-shrinkable film (A)/(B), comprising
a thermoplastic heat-sealable layer (A),
a thermoplastic mono or multilayer base layer (B) directly adhered to layer (A),
wherein the surface of the base layer (B) not directly adhered to layer (A) is a rough surface,
ii) applying to the rough surface of the base layer (B) a hydrophobic coating composition,
iii) curing and/or drying the applied hydrophobic coating composition, thus forming a super-hydrophobic coating (C).

15. The process according to claim 14 wherein, in step i), the surface of the base layer (B) not directly adhered to layer (A) of the uncoated film (A)/(B) was made rough by superficial treatments with mechanical and/or chemical methods or by incorporation of micro-particles in the base layer (B) at coextrusion of the film (A)/(B).

16. The process according to claim 14 wherein, in step ii), the amount of the hydrophobic coating composition applied to the rough surface of the base layer (B) not directly adhered to layer (A) of the uncoated film (A)/(B) is from 4 to 50 g/m² (wet grammage).

17. A flexible article for packaging, in the form of a seamless tubing or of a flexible container, having at least an opening for introducing a product, the article being made from a super-hydrophobic thermoplastic multilayer packaging film comprising:
an outer thermoplastic heat-sealable layer (A),
an inner thermoplastic mono or multilayer base layer (B) directly adhered to layer (A),
an outer super-hydrophobic coating (C) directly adhered to layer (B),
wherein the surface of the base layer (B) directly adhered to the coating (C) is a rough surface and the outer surface of the coating (C) not directly adhered to layer (B), has a water contact angle θ measured according to test method ASTM D7490-13 higher than 130°, wherein the outermost surface of the article is the super-hydrophobic surface of the coating (C) having a water contact angle 0 measured according to test method ASTM D7490-13 higher than 130°.

18. The flexible article of claim 17 wherein the flexible article is a hermetic package in which the film hermetically enclose a product, wherein the outer most surface of the package is the super-hydrophobic surface of the coating (C) having a water contact angle θ measured according to test method ASTM D7490-13 higher than 130°.

19. The hermetic package according to claim 18, wherein said hermetic package is vacuum shrunk.

20. (canceled)

21. The hermetic package of claim 18 wherein the packaged product is a food product, selected among meat, poultry, cheese, fish, processed or smoked meat, pork and lamb, baby food, beverages, preferably selected among milk, wine, beer, fruit juices.

22. (canceled)
